(19) United States
(12) Patent Application Publication
(10) Pub. No.: US 2026/0006405 A1
(43) Pub. Date: Jan. 1, 2026

(54) LOCATION DETERMINATION FOR WEARABLE DEVICES

(71) Applicant: Snap Inc., Santa Monica, CA (US)

(72) Inventors: Piotr Gurgul, Hergiswil (CH); Hsuan-Yu Lin, Küsnacht (CH); Lucas Rangit Magasweran, Berlin (DE); Pawel Wawruch, Freienbach (CH)

(21) Appl. No.: 18/757,159

(22) Filed: Jun. 27, 2024

(51) Int. Cl. H04W 4/029; G01S 19/01

(52) U.S. Cl. CPC H04W 4/029; G01S 19/01

(57) ABSTRACT

Systems, methods, and computer readable media for location determination for battery-constrained devices, where the methods performed on a system include determining a location source of a plurality of location sources to query for location data, where the determination is based on a current location, conditions of the system, and a plurality location requests from one or more applications. The methods may further include querying the determined location source, accessing location data from the determined location source, fusing the location data with the current location to generate a new current location, and storing the new current location data in a memory accessible to the one or more applications.

### TECHNICAL FIELD

Examples of the present disclosure relate generally to determining location data for a mobile device. More particularly, but not by way of limitation, examples of the present disclosure relate to evaluating requests for location data, such as a request for geographic location, from applications within the mobile device and determining a location source and a time to request the location data from the location source where the determination is based on reducing the power usage and improving the accuracy of the location data provided to the applications.

### BACKGROUND

Geographic location is often used by many application modules of a wearable mobile device to enhance a user's experience with a wearable mobile device. However, determining a geographic location of the mobile device consumes power and mobile devices are often limited by batteries. Additionally, application programs may request frequent updates to the geographic location of the mobile device.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 is a diagrammatic representation of a message, according to some examples.

FIG. 5 illustrates a system in which the head-wearable apparatus, according to some examples.

FIG. 6 is a diagrammatic representation of a machine in the form of a computer system within which a set of instructions may be executed to cause the machine to perform any one or more of the methodologies discussed herein, according to some examples.

FIG. 7 is a block diagram showing a software architecture within which examples may be implemented.

FIG. 8 is a perspective view of a head-wearable apparatus in the form of glasses, in accordance with some examples.

FIG. 9 illustrates a system for sources of location data for a mobile device, in accordance with some examples.

FIG. 10 illustrates a system for location determination for battery-constrained devices, in accordance with some examples.

FIG. 11 illustrates a system for location determination for battery-constrained devices, in accordance with some examples.

FIG. 12 illustrates queues, in accordance with some examples.

FIG. 13 illustrates a method for location determination for battery-constrained devices, in accordance with some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

Users of mobile devices enjoy the services provided by applications that can ascertain the current location of the mobile device. For example, a geographic location aware application on an augmented reality (AR), extended reality (XR), or virtual reality (VR) head-wearable device (“XR head-wearable device”) can provide information regarding monuments that the user of the XR head-wearable device is near such as the Eiffel Tower or Empire State Building. In another example, an application may use the location data to provide directions to the user of the XR head-wearable device. Many other applications on a mobile device may be enhanced if the current location of the mobile device is known. Example embodiments include providing location data to applications while doing one or more of the following: lessening the latency of providing the location data, increasing the accuracy of the location data, and lessening the amount of power that is used to determine the location data.

The requests for location data often include an accuracy requirement. The accuracy requirement can be categorized into three categories: low, medium, and high. Low accuracy may be required by applications such as an image capturing application that would like to have a current location associated with a captured image. For instance, the image capturing application may only want a locality to associate with the captured image and thus, a low accuracy is sufficient for these applications. Medium accuracy may be required by applications such as a mapping or navigation application where a position to within a foot or two is sufficient to provide directions. High accuracy may be required by applications such as games where the movement of the user of the mobile device needs to be measured to an accuracy of a centimeter or less. In some games, a medium accuracy may be required where the location needs are not as demanding such as XR games where the location may be supplemented by other information. A request for location data may include a type of location information such as weather, altitude, geographic, relative difference in location, velocity, and/or locality. The request for location data additionally may include both a time when the location data is requested and a freshness value, which indicates how old the location data may be to satisfy the location request. For example, a request for location data may indicate that a freshness of one second is acceptable, which indicates that location data that was obtained one second ago or less from a location source is acceptable to satisfy the request for location data.

In some examples, location requests are queued based on the requested accuracy and the time when the application is requesting the location data. For example, there may be three queues, one for low accuracy, one for medium accuracy, and one for high accuracy, that are ordered in accordance with when the location data is requested to be sent to the application or made available to the application. For example, an application sends a request for location data with a time that indicates the location data is needed in three seconds from the present time. To satisfy a request for location data, the system queries a location source, which returns location data after a latency period. Location sources may require more power than other location sources. For example, querying a location source that is on-board or part of the system and provides dead reckoning location data requires less power than determining the location data based on received satellite signals. The location sources may be categorized into lower power location source, medium power location sources, and higher power location sources.

A technical problem is how to provide current location data to applications on a mobile device while decreasing the amount of power used to provide the current location data. In some examples, the technical problem is addressed by determining a highest accuracy location request from queued location requests. The location data returned by satisfying the selected location request is used to satisfy other pending location requests in the queues that have location request times not after a time of the selected location request. The location request times of the pending requests are determined taking into consideration the freshness of the location requests. For example, if a freshness of a pending location request indicates that the location data used to satisfy this pending location request may be 1 second old, then this pending location request may be satisfied with the location data returned by satisfying the selected location request as long as the location data is returned not more than 1 second before the time to satisfy this pending location request.

For example, the lower accuracy location requests on the queues can be satisfied with the higher accuracy location data returned by the higher accuracy location data returned by satisfying the selected location request. The highest accuracy location request is satisfied by selecting an appropriate location source that can provide location data within the time required and with the appropriate accuracy. By considering all the pending location requests, more than one location request can be satisfied with the same location data, which reduces power usage. Additionally, a location request with a time after the highest accuracy location request may be satisfied as well if the freshness requirement extends to a time of when the location data was returned in satisfying the highest accuracy location request. For example, the highest accuracy location request may be satisfied at time t and there may be another request for location data on the queues that indicates a freshness of one second is acceptable and may have a time for delivering the location data to satisfy the request for location data of t plus one second.

Additionally, in some examples, the technical problem is addressed by fusing a current location with new location data to enable a lower power location source to be used to generate the location data. For example, if the current location has a high accuracy and the location data request is for medium accuracy location data, a low accuracy location source may be used to provide fused medium accuracy location data. The details of fusing location data is provided herein.

Moreover, in some examples, the technical problem is addressed by maintaining metrics of the use of the location sources. For example, a latency and power usage may be determined for using a satellite location source. The latency and power associated with the satellite location source is then adjusted according to actual use. This enables the mobile device to determine which location source to use based on more accurate information regarding the latency and power usage of the location resources. Additionally, conditions that affect the characteristics of using a location resource are maintained. For example, if the mobile device is indoors, then the estimate amount of power to use the satellite location resource is increased.

### Networked Computing Environment

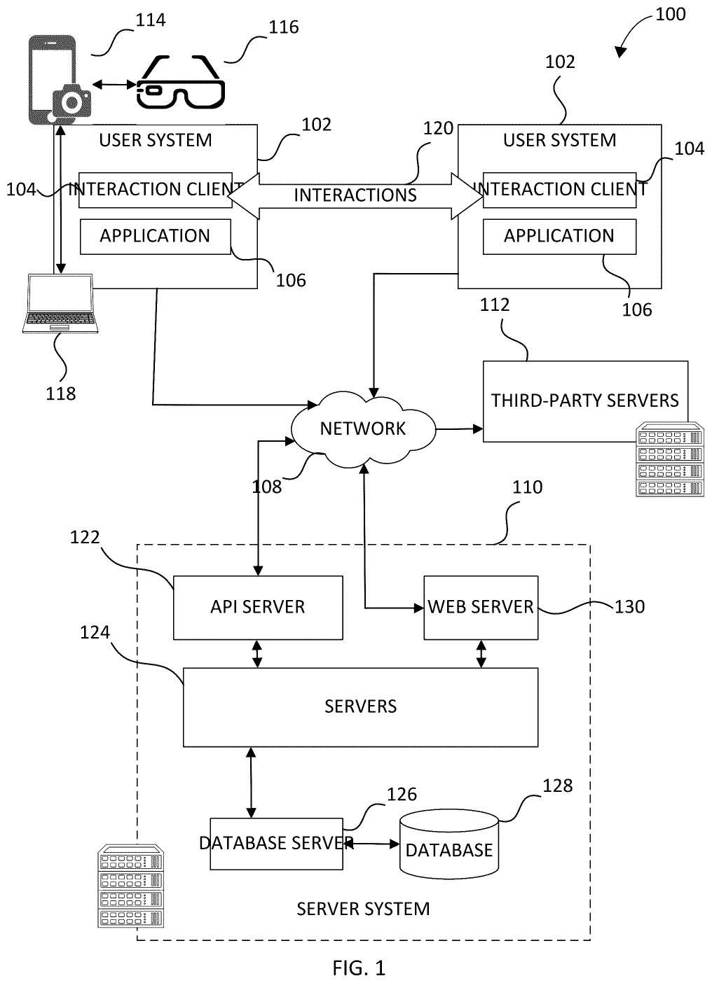

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

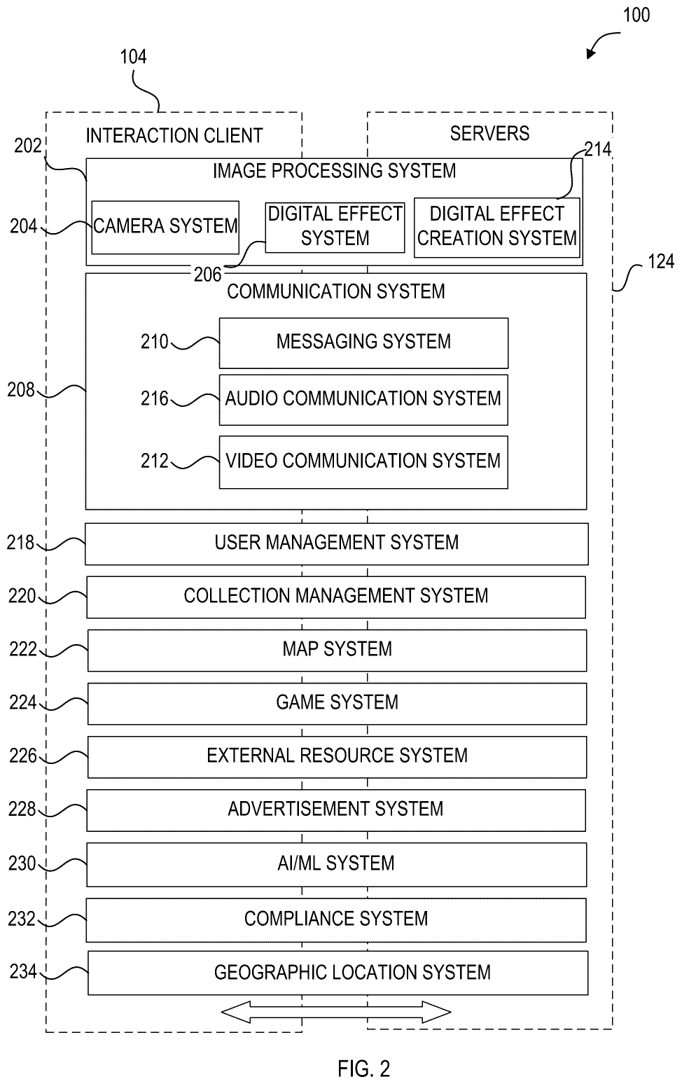

The servers 124 host multiple systems and subsystems, described below with reference to FIG. 2.

### External Resources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user's system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

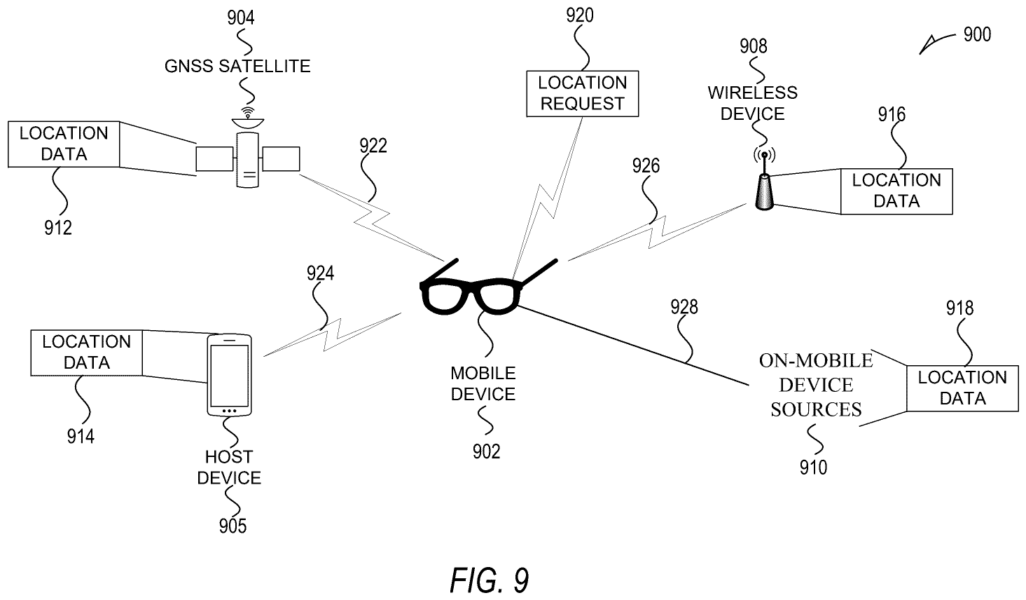

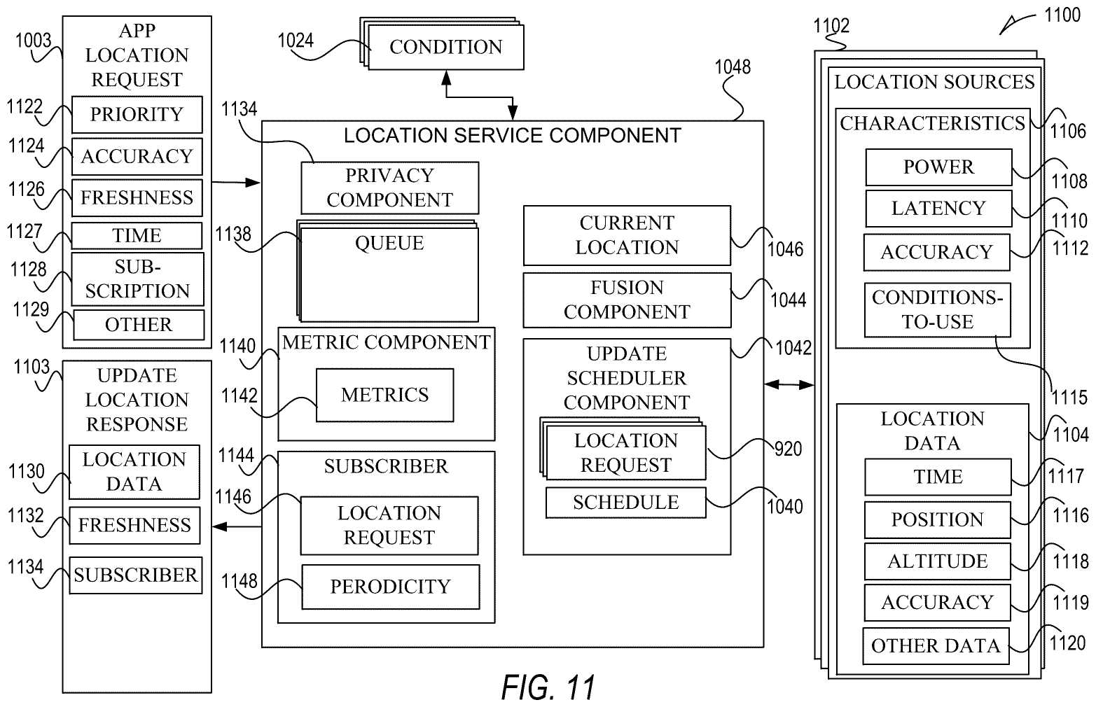

The geographic location system 234 provides various functions to determine a current location 1046 (see FIG. 11) of the mobile device 902 (see FIG. 9.) In some examples, the geographic location system 234 interfaces with external devices to determine a current location 1046 of the mobile device 902. In some examples, the geographic location system 234 responds to requests for geographic location information from a mobile device 902. In some examples, the geographic location system 234 provides information to assist a mobile device 902 in determining a geographic location such as almanac data for a GNSS system or information regarding other wireless devices with which the mobile device 902 may interact with to determine a geographic location of the mobile device 902.

An image processing system 202 provides various functions that enable a user to capture and modify (e.g., augment, annotate or otherwise edit) media content associated with a message.

A camera system 204 includes control software (e.g., in a camera application) that interacts with and controls hardware camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 502 of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308 and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Data Architecture

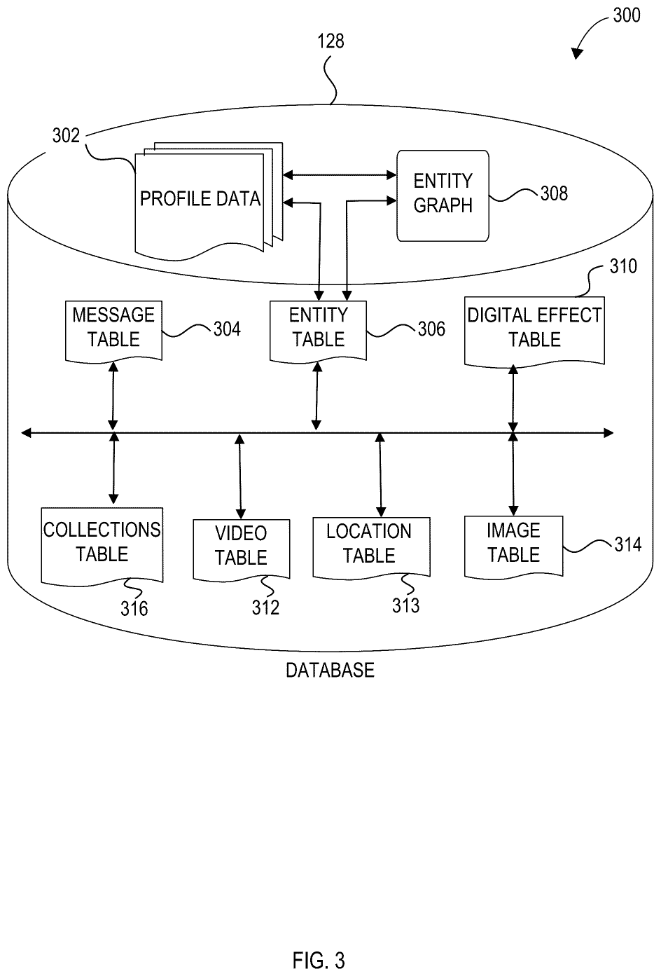

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data that may be stored within the image table 314 includes augmented reality content items (e.g., corresponding to augmented reality experiences). An augmented reality content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304. Similarly, the image table 314 stores image data associated with messages for which message data is stored in the entity table 306. The entity table 306 may associate various digital effects from the digital effect table 310 with various images and videos stored in the image table 314 and the video table 312.

The database 128 also includes a location table 313, which includes support information for the geographic location system 234. The location table 313 includes data associated with, referring to FIG. 9, the GNSS satellites 904, wireless devices 908, and so forth. The data stored in the location table 313 may be requested by the geographic location system 234 in assisting the mobile device 902 in determining a current location 1046.

### Data Communications Architecture

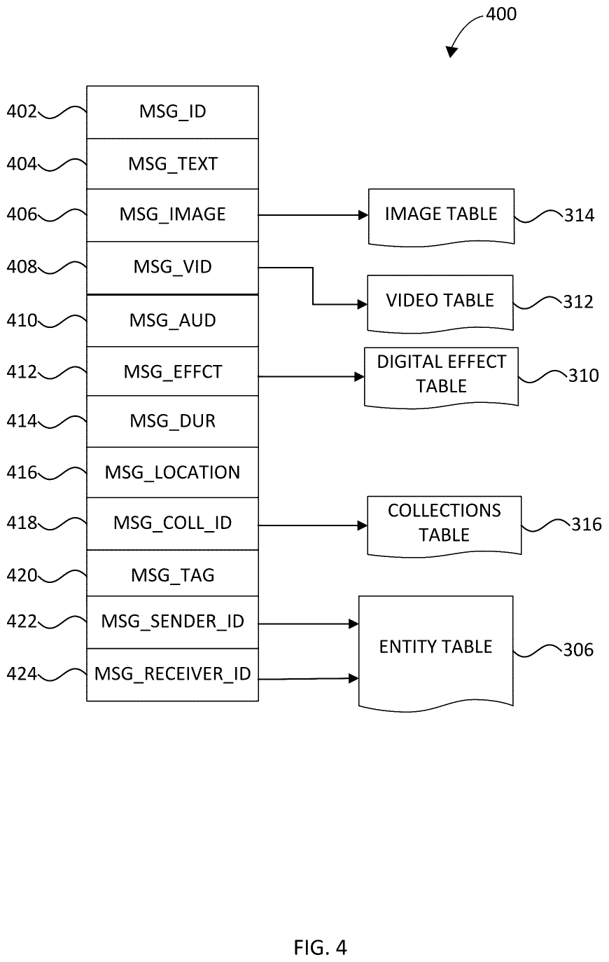

FIG. 4 is a schematic diagram illustrating a structure of a message 400, according to some examples, generated by an interaction client 104 for communication to a further interaction client 104 via the servers 124. The content of a particular message 400 is used to populate the message table 304 stored within the database 128, accessible by the servers 124. Similarly, the content of a message 400 is stored in memory as “in-transit” or “in-flight” data of the user system 102 or the servers 124. A message 400 is shown to include the following example components:
Message identifier 402: a unique identifier that identifies the message 400.
Message text payload 404: text, to be generated by a user via a user interface of the user system 102, and that is included in the message 400.
Message image payload 406: image data, captured by a camera component of a user system 102 or retrieved from a memory component of a user system 102, and that is included in the message 400. Image data for a sent or received message 400 may be stored in the image table 314.
Message video payload 408: video data, captured by a camera component or retrieved from a memory component of the user system 102, and that is included in the message 400. Video data for a sent or received message 400 may be stored in the video table 312.
Message audio payload 410: audio data, captured by a microphone or retrieved from a memory component of the user system 102, and that is included in the message 400.
Message digital effect data 412: digital effect data (e.g., filters, stickers, or other annotations or enhancements) that represents digital effects to be applied to message image payload 406, message video payload 408, or message audio payload 410 of the message 400. Digital effect data for a sent or received message 400 may be stored in the digital effect table 310.
Message duration parameter 414: parameter value indicating, in seconds, the amount of time for which content of the message (e.g., the message image payload 406, message video payload 408, message audio payload 410) is to be presented or made accessible to a user via the interaction client 104.
Message geolocation parameter 416: geolocation data (e.g., latitudinal, and longitudinal coordinates) associated with the content payload of the message. Multiple message geolocation parameter 416 values may be included in the payload, each of these parameter values being associated with respect to content items included in the content (e.g., a specific image within the message image payload 406, or a specific video in the message video payload 408).
Message collection identifier 418: identifier values identifying one or more content collections (e.g., “stories” identified in the collections table 316) with which a particular content item in the message image payload 406 of the message 400 is associated. For example, multiple images within the message image payload 406 may each be associated with multiple content collections using identifier values.
Message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
Message sender identifier 422: an identifier (e.g., a messaging system identifier, email address, or device identifier) indicative of a user of the user system 102 on which the message 400 was generated and from which the message 400 was sent.
Message receiver identifier 424: an identifier (e.g., a messaging system identifier, email address, or device identifier) indicative of a user of the user system 102 to which the message 400 is addressed.

The contents (e.g., values) of the various components of message 400 may be pointers to locations in tables within which content data values are stored. For example, an image value in the message image payload 406 may be a pointer to (or address of) a location within an image table 314. Similarly, values within the message video payload 408 may point to data stored within a video table 314, values stored within the message digital effect data 412 may point to data stored in a digital effect table 310, values stored within the message collection identifier 418 may point to data stored in a collections table 316, and values stored within the message sender identifier 422 and the message receiver identifier 424 may point to user records stored within an entity table 306.

System with Head-Wearable Apparatus

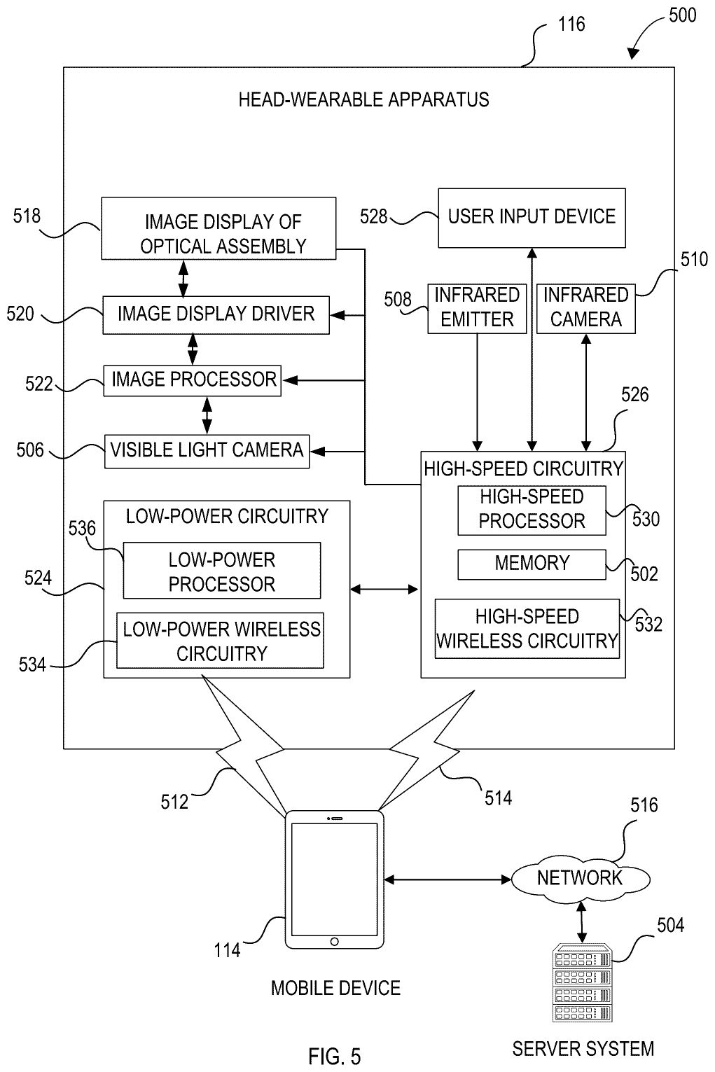

FIG. 5 illustrates a system 500 including a head-wearable apparatus 116 with a selector input device, according to some examples. FIG. 5 is a high-level functional block diagram of an example head-wearable apparatus 116 communicatively coupled to a mobile device 114 and various server systems 504 (e.g., the server system 110) via various networks 108.

The head-wearable apparatus 116 includes one or more cameras, each of which may be, for example, a visible light camera 506, an infrared emitter 508, and an infrared camera 510.

The mobile device 114 connects with head-wearable apparatus 116 using both a low-power wireless connection 512 and a high-speed wireless connection 514. The mobile device 114 is also connected to the server system 504 and the network 516.

The head-wearable apparatus 116 further includes two image displays of the image display of optical assembly 518. The two image displays of optical assembly 518 include one associated with the left lateral side and one associated with the right lateral side of the head-wearable apparatus 116. The head-wearable apparatus 116 also includes an image display driver 520, an image processor 522, low-power circuitry 524, and high-speed circuitry 526. The image display of optical assembly 518 is for presenting images and videos, including an image that can include a graphical user interface to a user of the head-wearable apparatus 116.

The image display driver 520 commands and controls the image display of optical assembly 518. The image display driver 520 may deliver image data directly to the image display of optical assembly 518 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 528 (e.g., touch sensor or push button), including an input surface on the head-wearable apparatus 116. The user input device 528 (e.g., touch sensor or push button) is to receive from the user an input selection to manipulate the graphical user interface of the presented image.

The components shown in FIG. 5 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 506 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 502, which stores instructions to perform a subset, or all the functions described herein. The memory 502 can also include storage device.

As shown in FIG. 5, the high-speed circuitry 526 includes a high-speed processor 530, a memory 502, and high-speed wireless circuitry 532. In some examples, the image display driver 520 is coupled to the high-speed circuitry 526 and operated by the high-speed processor 530 to drive the left and right image displays of the image display of optical assembly 518. The high-speed processor 530 may be any processor capable of managing high-speed communications and operation of any general computing system needed for the head-wearable apparatus 116. The high-speed processor 530 includes processing resources needed for managing high-speed data transfers on a high-speed wireless connection 514 to a wireless local area network (WLAN) using the high-speed wireless circuitry 532. In certain examples, the high-speed processor 530 executes an operating system such as a LINUX operating system or other such operating system of the head-wearable apparatus 116, and the operating system is stored in the memory 502 for execution. In addition to any other responsibilities, the high-speed processor 530 executing a software architecture for the head-wearable apparatus 116 is used to manage data transfers with high-speed wireless circuitry 532. In certain examples, the high-speed wireless circuitry 532 is configured to implement Institute of Electrical and Electronic Engineers (IEEE) 802.11 communication standards, also referred to herein as WI-FI®. In some examples, other high-speed communications standards may be implemented by the high-speed wireless circuitry 532.

The low-power wireless circuitry 534 and the high-speed wireless circuitry 532 of the head-wearable apparatus 116 can include short-range transceivers (e.g., Bluetooth™, Bluetooth LE, Zigbee, ANT+) and wireless wide, local, or wide area network transceivers (e.g., cellular or WI-FIR). Mobile device 114, including the transceivers communicating via the low-power wireless connection 512 and the high-speed wireless connection 514, may be implemented using details of the architecture of the head-wearable apparatus 116, as can other elements of the network 516.

The memory 502 includes any storage device capable of storing various data and applications, including, among other things, camera data generated by the left and right visible light cameras 506, the infrared camera 510, and the image processor 522, as well as images generated for display by the image display driver 520 on the image displays of the image display of optical assembly 518. While the memory 502 is shown as integrated with high-speed circuitry 526, in some examples, the memory 502 may be an independent standalone element of the head-wearable apparatus 116. In certain such examples, electrical routing lines may provide a connection through a chip that includes the high-speed processor 530 from the image processor 522 or the low-power processor 536 to the memory 502. In some examples, the high-speed processor 530 may manage addressing of the memory 502 such that the low-power processor 536 will boot the high-speed processor 530 any time that a read or write operation involving memory 502 is needed.

As shown in FIG. 5, the low-power processor 536 or high-speed processor 530 of the head-wearable apparatus 116 can be coupled to the camera (visible light camera 506, infrared emitter 508, or infrared camera 510), the image display driver 520, the user input device 528 (e.g., touch sensor or push button), and the memory 502.

The head-wearable apparatus 116 is connected to a host computer. For example, the head-wearable apparatus 116 is paired with the mobile device 114 via the high-speed wireless connection 514 or connected to the server system 504 via the network 516. The server system 504 may be one or more computing devices as part of a service or network computing system, for example, that includes a processor, a memory, and network communication interface to communicate over the network 516 with the mobile device 114 and the head-wearable apparatus 116.

The mobile device 114 includes a processor and a network communication interface coupled to the processor. The network communication interface allows for communication over the network 516, low-power wireless connection 512, or high-speed wireless connection 514. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 520. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 504, such as the user input device 528, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any I/O components including output components, motion components, position components, or any other such elements described herein.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 512 and high-speed wireless connection 514 from the mobile device 114 via the low-power wireless circuitry 534 or high-speed wireless circuitry 532.

### Machine Architecture

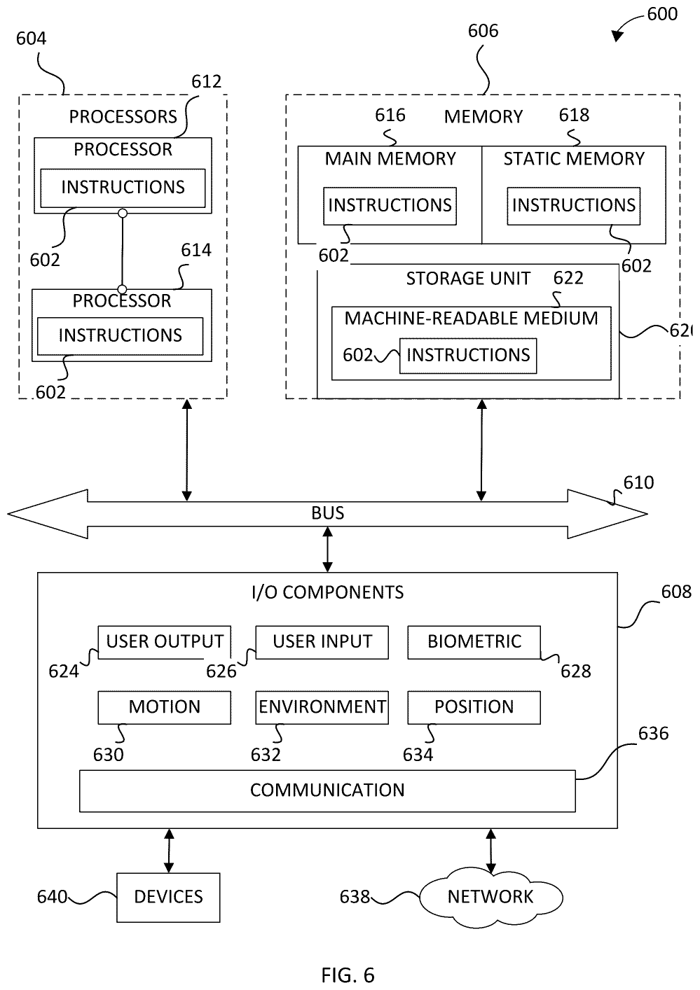

FIG. 6 is a diagrammatic representation of the machine 600 within which instructions 602 (e.g., software, a program, an application, an applet, an app, or other executable code) for causing the machine 600 to perform any one or more of the methodologies discussed herein may be executed. For example, the instructions 602 may cause the machine 600 to execute any one or more of the methods described herein. The instructions 602 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 602, sequentially or otherwise, that specify actions to be taken by the machine 600. Further, while a single machine 600 is illustrated, the term “machine” shall also be taken to include a collection of machines that individually or jointly execute the instructions 602 to perform any one or more of the methodologies discussed herein. The machine 600, for example, may comprise the user system 102 or any one of multiple server devices forming part of the server system 110. In some examples, the machine 600 may also comprise both client and server systems, with certain operations of a particular method or algorithm being performed on the server-side and with certain operations of the method or algorithm being performed on the client-side.

The machine 600 may include processors 604, 612, 614, memory 606, and input/output I/O components 608, which may be configured to communicate with each other via a bus 610.

The memory 606 includes a main memory 616, a static memory 618, and a storage unit 620, both accessible to the processors 604 via the bus 610. The main memory 606, the static memory 618, and storage unit 620 store the instructions 602 embodying any one or more of the methodologies or functions described herein. The instructions 602 may also reside, completely or partially, within the main memory 616, within the static memory 618, within machine-readable medium 622 within the storage unit 620, within at least one of the processors 604 (e.g., within the processor's cache memory), or any suitable combination thereof, during execution thereof by the machine 600.

The I/O components 608 may include a wide variety of components to receive input, provide output, produce output, transmit information, exchange information, capture measurements, and so on. The specific I/O components 608 that are included in a particular machine will depend on the type of machine. For example, portable machines such as mobile phones may include a touch input device or other such input mechanisms, while a headless server machine will likely not include such a touch input device. It will be appreciated that the I/O components 608 may include many other components that are not shown in FIG. 6. In various examples, the I/O components 608 may include user output components 624 and user input components 626. The user output components 624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In some examples, the head-wearable apparatus 116 may include biometric 628 components or sensors to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information. The position 634 component may determine a position of the machine 600. Methods and apparatuses are described herein that determine position 634.

The motion components 630 include acceleration sensor components (e.g., accelerometer), gravitation sensor components, rotation sensor components (e.g., gyroscope).

The environmental components 632 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 608 further include communication components 636 operable to couple the machine 600 to a network 638 or devices 640 via respective coupling or connections. For example, the communication components 636 may include a network interface component or another suitable device to interface with the network 638. In further examples, the communication components 636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 640 may be another machine or any of a wide variety of peripheral devices (e.g., a peripheral device coupled via a USB).

Moreover, the communication components 636 may detect identifiers or include components operable to detect identifiers. For example, the communication components 636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 636, such as location via Internet Protocol (IP) geolocation, location via Wi-Fi® signal triangulation, location via detecting an NFC beacon signal that may indicate a particular location, and so forth.

The various memories (e.g., main memory 616, static memory 618, and memory of the processors 604) and storage unit 620 may store one or more sets of instructions and data structures (e.g., software) embodying or used by any one or more of the methodologies or functions described herein. These instructions (e.g., the instructions 602), when executed by processors 604, cause various operations to implement the disclosed examples.

The instructions 602 may be transmitted or received over the network 638, using a transmission medium, via a network interface device (e.g., a network interface component included in the communication components 636) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 640.

### Software Architecture

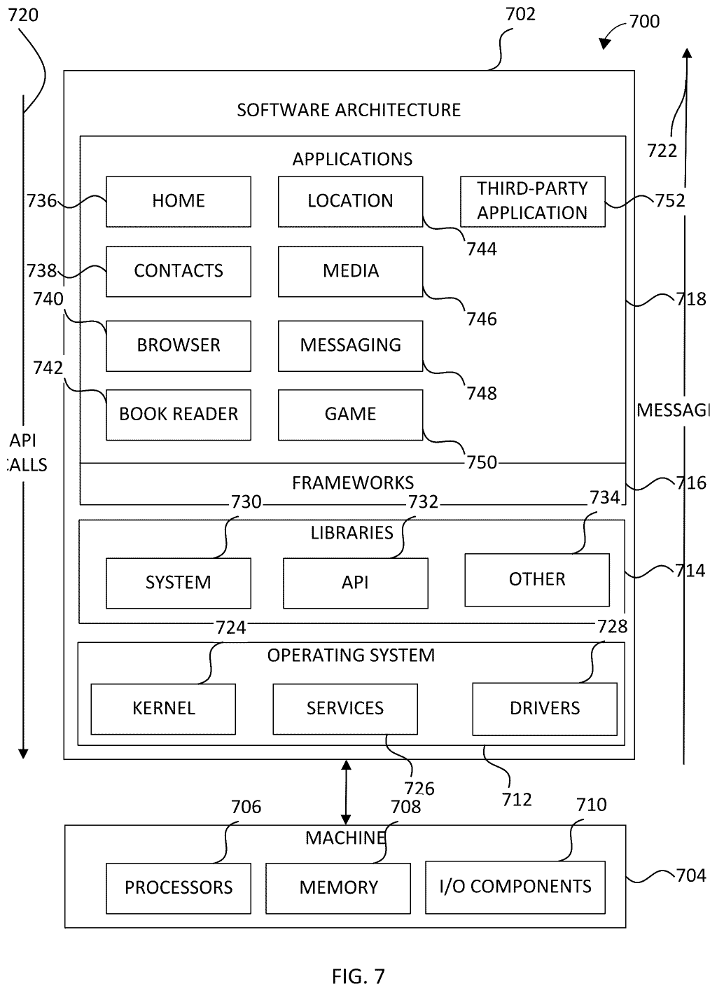

FIG. 7 is a block diagram 700 illustrating a software architecture 702, which can be installed on any one or more of the devices described herein. The software architecture 702 is supported by hardware such as a machine 704 that includes processors 706, memory 708, and I/O components 710. In this example, the software architecture 702 can be conceptualized as a stack of layers, where each layer provides a particular functionality. The software architecture 702 includes layers such as an operating system 712, libraries 714, frameworks 716, and applications 718. Operationally, the applications 718 invoke API calls 720 through the software stack and receive messages 722 in response to the API calls 720.

The operating system 712 manages hardware resources and provides common services. The operating system 712 includes, for example, a kernel 724, services 726, and drivers 728. The kernel 724 acts as an abstraction layer between the hardware and the other software layers. For example, the kernel 724 provides memory management, processor management (e.g., scheduling), component management, networking, and security settings, among other functionalities. The services 726 can provide other common services for the other software layers. The drivers 728 are responsible for controlling or interfacing with the underlying hardware. For instance, the drivers 728 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 714 provide a common low-level infrastructure used by the applications 718. The libraries 714 can include system libraries 730 (e.g., C standard library) that provide functions such as memory allocation functions, string manipulation functions, mathematical functions, and the like. In addition, the libraries 714 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 714 can also include a wide variety of other libraries 734 to provide many other APIs to the applications 718.

The frameworks 716 provide a common high-level infrastructure that is used by the applications 718. For example, the frameworks 716 provide various graphical user interface (GUI) functions, high-level resource management, and high-level location services. The frameworks 716 can provide a broad spectrum of other APIs that can be used by the applications 718, some of which may be specific to a particular operating system or platform.

In an example, the applications 718 may include a home application 736, a contacts application 738, a browser application 740, a book reader application 742, a location application 744, a media application 746, a messaging application 748, a game application 750, and a broad assortment of other applications such as a third-party application 752. The applications 718 are programs that execute functions defined in the programs. Various programming languages can be employed to create one or more of the applications 718, structured in a variety of manners, such as object-oriented programming languages (e.g., Objective-C, Java, or C++) or procedural programming languages (e.g., C or assembly language). In a specific example, the third-party application 752 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 752 can invoke the API calls 720 provided by the operating system 712 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

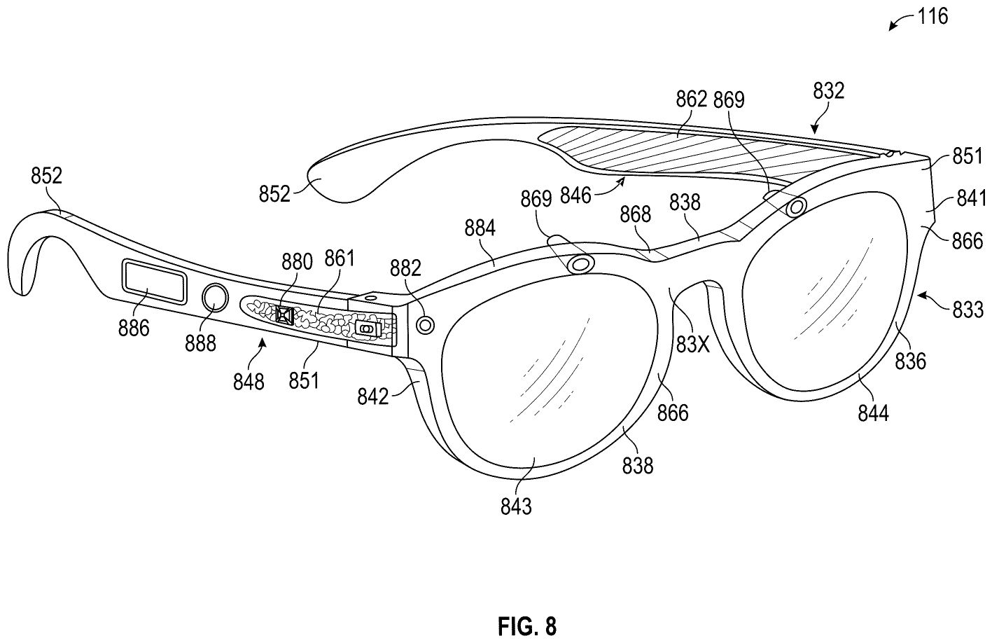

FIG. 8 is a perspective view of a head-wearable apparatus in the form of glasses 800, in accordance with some examples. The glasses 800 are an article of eyewear including electronics, which operate within a network system for communicating image and video content. FIG. 8 illustrates an example of the head-wearable apparatus 116. In some examples, the wearable electronic device is termed augmented reality (AR), mixed reality (MR), virtual reality (VR), and/or extended reality (XR) glasses. The glasses 800 can include a frame 832 made from any suitable material such as plastic or metal, including any suitable shape memory alloy. The frame 832 can have a front piece 833 that can include a first or left lens, display, or optical element holder 836 and a second or right lens, display, or optical element holder 837 connected by a bridge 838. The front piece 833 additionally includes a left end portion 841 and a right end portion 842. A first or left optical element 844 and a second or right optical element 843 can be provided within respective left and right optical element holders 836, 837. Each of the optical elements 843, 844 can be a lens, a display, a display assembly, or a combination of the foregoing. In some examples, for example, the glasses 800 are provided with an integrated near-eye display mechanism that enables, for example, display to the user of preview images for visual media captured by cameras 869 of the glasses 800.

The frame 832 additionally includes a left arm or temple piece 846 and a right arm or temple piece 847 coupled to the respective left and right end portions 841, 842 of the front piece 833 by any suitable means such as a hinge (not shown), so as to be coupled to the front piece 833, or rigidly or fixedly secured to the front piece 833 so as to be integral with the front piece 833. Each of the temple pieces 846 and 847 can include a first portion 851 that is coupled to the respective end portion 841 or 842 of the front piece 833 and any suitable second portion 852, such as a curved or arcuate piece, for coupling to the ear of the user. In one example, the front piece 833 can be formed from a single piece of material, so as to have a unitary or integral construction. In one example, the entire frame 832 can be formed from a single piece of material so as to have a unitary or integral construction.

The glasses 800 include a computing device, such as a computer 861, which can be of any suitable type so as to be carried by the frame 832 and, in one example, of a suitable size and shape, so as to be at least partially disposed in one or more of the temple pieces 846 and 847. In one example, the computer 861 has a size and shape similar to the size and shape of one of the temple pieces 846, 847 and is thus disposed almost entirely if not entirely within the structure and confines of such temple pieces 846 and 847.

In one example, the computer 861 can be disposed in both of the temple pieces 846, 847. The computer 861 can include one or more processors with memory, wireless communication circuitry, and a power source. The computer 861 comprises low-power circuitry, high-speed circuitry, location circuitry, and a display processor. Various other examples may include these elements in different configurations or integrated together in different ways. Additional details of aspects of the computer 861 may be implemented as described with reference to the description that follows.

The computer 861 additionally includes a battery 862 or other suitable portable power supply. In one example, the battery 862 is disposed in one of the temple pieces 846 or 847. In the glasses 800 shown in FIG. 8, the battery 862 is shown as being disposed in the left temple piece 846 and electrically coupled using a connection 874 to the remainder of the computer 861 disposed in the right temple piece 847. One or more input and output devices can include a connector or port (not shown) suitable for charging a battery 862 accessible from the outside of the frame 832, a wireless receiver, transmitter, or transceiver (not shown), or a combination of such devices.

The glasses 800 include digital cameras 869. Although two cameras 869 are depicted, other examples contemplate the use of a single or additional (i.e., more than two) cameras 869. For ease of description, various features relating to the cameras 869 will be described further with reference to only a single camera 869, but it will be appreciated that these features can apply, in suitable examples, to both cameras 869.

In various examples, the glasses 800 may include any number of input sensors or peripheral devices in addition to the cameras 869. The front piece 833 is provided with an outward-facing, forward-facing, front, or outer surface 866 that faces forward or away from the user when the glasses 800 are mounted on the face of the user, and an opposite inward-facing, rearward-facing, rear, or inner surface 867 that faces the face of the user when the glasses 800 are mounted on the face of the user. Such sensors can include inward-facing video sensors or digital imaging components such as cameras 869 that can be mounted on or provided within the inner surface 867 of the front piece 833 or elsewhere on the frame 832 so as to be facing the user, and outward-facing video sensors or digital imaging components such as the cameras 869 that can be mounted on or provided with the outer surface 866 of the front piece 833 or elsewhere on the frame 832 so as to be facing away from the user. Such sensors, peripheral devices, or peripherals can additionally include biometric sensors, location sensors, accelerometers, or any other such sensors. In some examples, projectors (not illustrated) are used to project images on the inner surface of the optical elements 843, 844 (or lenses) to provide a mixed reality or augmented reality experience for the user of the glasses 800.

The glasses 800 further include an example of a camera control mechanism or user input mechanism comprising a camera control button mounted on the frame 832 for haptic or manual engagement by the user. The camera control button provides a bi-modal or single-action mechanism in that it is disposable by the user between only two conditions, namely an engaged condition and a disengaged condition. In this example, the camera control button is a push button that is by default in the disengaged condition, being depressible by the user to dispose it to the engaged condition. Upon release of the depressed camera control button, it automatically returns to the disengaged condition.

In other examples, the single-action input mechanism can instead be provided by, for example, a touch-sensitive button comprising a capacitive sensor mounted on the frame 832 adjacent to its surface for detecting the presence of a user's finger, to dispose the touch-sensitive button to the engaged condition when the user touches a finger to the corresponding spot on the outer surface 866 of the frame 832. It will be appreciated that the above-described camera control button and capacitive touch button are but two examples of a haptic input mechanism for single-action control of the camera 869, and that other examples may employ different single-action haptic control arrangements.

The computer 861 is configured to perform the methods described herein. In some examples, the computer 861 is coupled to one or more antennas for reception of signals from a GNSS and circuitry for processing the signals where the antennas and circuitry are housed in the glasses 800. In some examples, the computer 861 is coupled to one or more wireless antennas and circuitry for transmitting and receiving wireless signals where the antennas and circuitry are housed in the glasses 800. In some examples, there are multiple sets of antennas and circuitry housed in the glasses 800. In some examples, the antennas and circuitry are configured to operate in accordance with a communication protocol such as Bluetooth™, Low-energy Bluetooth™, IEEE 802, IEEE 802.11az/be, WiFI®, and so forth. In some examples, PDR sensors housed in glasses 800 and coupled to the computer 861. In some examples, the glasses 800 are VR headsets where optical elements 843, 844 are opaque screens for displaying images to a user of the VR headset. In some examples, the computer 861 is coupled to user interface elements such as slide or touchpad 876 and button 878. A long press of button 878 resets the glasses 800. The slide or touchpad 876 and button 878 are used for a user to provide input to the computer 861 and/or other electronic components of the glasses 800. The glasses 800 include one or more microphones 882 that are coupled to the computer 861. The glasses 800 include one or more gyroscopes 880.

### Location Determination for Battery-Constrained Devices

FIG. 9 illustrates a system 900 for sources of location data for a mobile device 902, in accordance with some examples. The mobile device 902 is a user system 102 of FIG. 1, in accordance with some examples. The mobile device 902 is a head-wearable apparatus 116 of FIG. 5, which may be the glasses 800 of FIG. 8, in accordance with some examples.

The mobile device 902 communicates with location sources 1102 of FIG. 11, which include Global Navigation Satellite System (GNSS) satellite 904, host device 905, wireless device 908, and on-mobile device sources 910. The location sources 1102 provide location data 912, 914, 916, 918. In some examples, the location data 912, 914, 916, 918 has one or more fields of location data 1104 of FIG. 11. For example, the location data 914 from the host device 905 may be assisted GNSS (AGNSS) data, an internet protocol (IP) location, a location of the host device 905, a location of the host device 905 with an estimate of a distance the mobile device 902 is from the host device 905, and so forth. Location data 912, 914, 916, 918 is discussed further below in conjunction with Table 2.

The GNSS satellite 904 is one or more satellites that the mobile device 902 communicates with to determine location data 912. The mobile device 902 uses differences in reception times from different GNSS satellites 904 and known positions of the GNSS satellites 904 to determine the location data 912. The AGNSS data is the known positions of the GNSS satellites 904, in some examples. Additionally, the host device 905 and wireless device 908 are configured to determine location data 912 of the host device 905 and wireless device 908, respectively, from GNSS satellites 904, in accordance with some examples.

The host device 905 is a paired smartphone device or companion device that provides services to the mobile device 902, in accordance with some examples. In some examples, the host device 905, or the mobile device 902, scans and collects data of nearby wireless devices such as access points (APs) of Institute of Electrical and Electronic Engineers (IEEE) wireless networks or base stations (BSs) of 3rd Generation Partnership Project (3GPP) wireless networks and determines a location of the APs or BSs and provides one or more of the locations of the APs or BSs to the mobile device 902 as location data 914. The host device 905 or the mobile device 902 determines the locations of the APs or BSs by performing a lookup of the location of the APs or BSs in a database 128, requesting their locations from a server device, or determining their locations based on a known location of the host device 905.

The wireless device 908 is configured to operate in accordance with one or more communication standards such as IEEE 802, 3GPP, LTE, LTE-Advanced, 5G communications, Bluetooth®, low-energy Bluetooth®, and so forth. In some examples, the wireless device 908 is a 3GPP BS, 5G BS, or an IEEE AP. The wireless device 908 and mobile device 902 are configured to operate in accordance with one or more communication protocols to determine a location of the mobile device 902. For example, the communication protocol may be IEEE 802.11az, WiFi positioning service (WFPS), a proprietary protocol, or another communication protocol for determining location. The wireless device 908 may be multiple devices. For example, the wireless device 908 may be two IEEE 802.11az APs that perform a triangulation method with the mobile device 902 to determine a location of the mobile device 902. The communication 926 may be a beacon such as BLE beacon or a Bluetooth® beacon that the mobile device 902 may use to determine location data 1104.

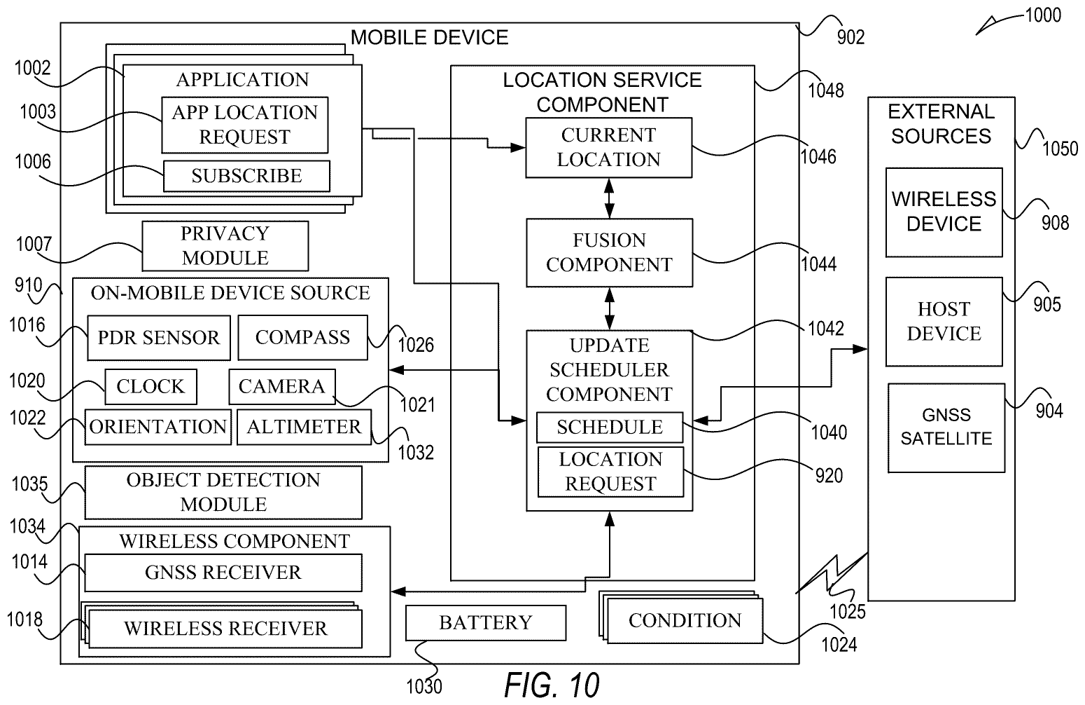

The on-mobile device sources 910 are location sources 1102 that are part of the mobile device 902. An example on-mobile device source 910 is a pedestrian dead reckoning (PDR) sensor 1016 of FIG. 10. The PDR sensor 1016 generates location data 918 based on motion of the mobile device 902. The PDR sensor 1016 includes sensors such as a gyroscope and generates location data 918 to estimate the distance and direction that mobile device 902 moves from a current location 1046 of FIG. 10.

The mobile device 902 sends a location request 920 to a location source 1102 such as GNSS satellite 904, host device 905, wireless device 908, or on-mobile device source 910 over communications 922, 924, 926, 928, respectively. The location sources 1102 such as GNSS satellite 904, host device 905, wireless device 908, or on-mobile device source 910 sends communications 922, 924, 926, 928, respectively, that includes location data 912, 914, 916, 918, respectively, in response to the location request 920. In some examples the location data 912, 914, 916, and 918 is sent without a location request 920.

The mobile device 902 makes a location request 920 for location data 912, 914, 916, 918 to a location source 1102, which may be a component within the mobile device 902. Table 1 provides characteristics of location sources 1102. In Table 1 the characteristics 1106, which are also disclosed in conjunction with FIG. 11, include accuracy 1112, latency 1110, power 1108, and conditions-to-use 1115. The characteristics 1106 are for the indicated location data 1104 for the location source 1102. The characteristics 1106 may be different for different types of location sources 1102.

The conditions-to-use 1115 of Table 1 and FIG. 11 are conditions or prerequisites that are either necessary for the use of the positioning system or needed to make use of the location source 1102 more efficiently in terms of power usage or other operating characteristics. For example, if the GNSS satellite 904 is used indoors, then it requires more power 1108 and may require a greater latency 1110.

TABLE 1
Characteristics of Location Sources

| | | Characteristic 1106 | | | | |
|---|---|---|---|---|---|---|
| Location source | Location data | Accuracy | Latency | Power | Indoor/ | Conditions-to-use |
| 1102 | 1104 | 1112 | 1110 | 1108 | Outdoor | 1115 |
| GNSS | GNSS data | Higher | Higher | Higher | Outdoor | Antenna with |
| satellite 904 | | | | | | higher signal/ |
| | | | | | | noise ratio |
| Host | AGNSS data | Medium | Lower | Lower | Both | Bluetooth/Wireless |
| device 905 | | | | | | connection |
| Host | Other | Variable | Variable | Variable | Both | Wireless |
| device 905 | location data | | | | | connection |
| Wireless | WFPS data | Higher | Medium | Lower | Indoor | Availability of |
| device 908 | | | | | | wireless protocol. |
| | | | | | | Availability of |
| | | | | | | IEEE 802.11 |
| | | | | | | network. |
| | | | | | | Availability of |
| | | | | | | 3GPP network. |
| On-mobile | PDR data, | Lower | Lower | Lower | Both | Prior Position |
| device | compass, | | | | | |
| sources 910 | clock, | | | | | |
| | orientation, | | | | | |
| | altimeter, | | | | | |
| | and so forth | | | | | |
| On-mobile | light sensor | Higher | Lower | Lower | Both | Availability of |
| device | and/or light | | | | | other devices to |
| sources 910 | emitter | | | | | perform location |
| | | | | | | services. |
| On-mobile | camera or | Higher | Medium | Power | Both | May require |
| device | image | | | | | Bluetooth/Wireless |
| sources 910 | capturing | | | | | connection with a |
| | device | | | | | host device. |

The conditions-to-use 1115 of Table 1, include antenna with a quality signal or high signal/noise ratio, Bluetooth connectivity, availability of wireless protocols, and a prior position. Other conditions-to-use 1115 not listed in Table 1 include the presence of host device 905 or paired mobile device, an application running on the host device 905 to respond to or service the mobile device 902, indoor or outdoor status, whether the mobile device 902 has a current fix on the GNSS satellites 904, whether the mobile device 902 has AGNSS data, which aids in a faster fix, whether other components in the mobile device 902 are operating, and so forth. The following is an example of a conditions-to-use 1115. The mobile device 902 determining location data 912 from GNSS satellite 904 signals requires a lot of power in processing the GNSS satellite 904 signals and determining the location data 912. If the GNSS satellite 904 signals are stronger, then less power 1108 is required. To reduce the amount of power 1108 used the mobile device 902 may refrain from using or prefer not to use the GNSS satellite 904 unless an antenna used to receive the GNSS satellite 904 signals indicates that there is a high signal-to-noise ratio. In some examples, the mobile device 902 refrains from using the GNSS satellite 904 signals unless the mobile device 902 is located outside to increase the chances that GNSS satellite 904 signals will have a high signal-to-noise ratio. The conditions-to-use 1115 may affect the latency 1110 as well. For example, without AGNSS data, the mobile device 902 may require up to ten times longer or more to get a fix on the GNSS satellites 904. The mobile device 902 is a low-power device that relies on batteries, in accordance with some examples.

Referring to Table 1, in some examples, the GNSS satellite 904 location source has the following characteristics: the location data 1104 determined is GNSS data; the accuracy is higher than some other location sources; the latency is higher because it takes a relatively longer time to obtain a fix and determine or receive the location data 912; the power required is higher than some others; the mobile device 902 needs to be located outdoors to receive the GNSS satellite 904 signals and reduce the power consumed in determining the location data 912, in accordance with some examples; and, a condition for use is an antenna with a higher signal-to-noise ratio in receiving the GNSS satellite 904 signals. Additional characteristics of the GNSS satellite 904 include that there is no requirement for an internet, wireless, or Bluetooth™ connection; the mobile device 902 needs a GNSS receiver 1014; and, acquiring AGNSS almanac data, which is helpful or necessary in acquiring a fix of the GNSS satellite 904 to determine the location data 912, is time consuming and may be acquired from the host device 905 or GNSS satellite 904. Additionally, the GNSS receiver 1014 is sensitive to other components operating near the GNSS receiver 1014. The GNSS receiver 1014 can operate with the electronic display such as image display of optical assembly 518 operating.

Referring to Table 1, in some examples, host device 905 has the following characteristics for AGNSS data: a medium accuracy since the approximated orbital data (ephemeris) is used with the GNSS satellite 904; low power usage because the AGNSS data and location request 920 reduce the time and power required to lock on the satellites; a medium latency to obtain a fix using AGNSS data as the low-energy wireless protocols have a higher latency than other wireless protocols; a low power requirement when LE Bluetooth™ is used; the AGNSS data may be provided by the host device 905 either indoors or outdoors, although the host device 905 may be better able to collect the AGNSS data indoors where WiFi is present; and, there is a requirement for the mobile device 902 and the host device 905 to be in communication via a wireless connection such as 3GPP, Bluetooth™, or IEEE 802.11 and there may be a requirement that a software component or application be running on the host device 905 to provide services to the mobile device 902.

Referring to Table 1, in some examples, host device 905 has the following characteristics for other location data 1104: a variable precision since the host device 905 may provide location data 914 in several different ways with different accuracies such as is described herein; a variable latency since the host device 905 may use a high energy wireless connection or a low energy wireless connection; a variable power usages since the host device 905 may use a high energy wireless connection or a low energy wireless connection; the host device 905 can connect with the mobile device 902 either indoors or outdoors; and, there is a requirement that the host device 905 be connected to the mobile device 902 via a wireless connection and there may be a requirement that a software component or application is running on the host device 905 to provide services to the mobile device 902.

In some examples, wireless device 908 has the following characteristics for WFPS location data 916, which is determined using triangulation based on signal strength or time-of-flight in transmitting and receiving packets between two or more wireless devices 908 and the mobile device 902; there is a higher precision with some of the communication protocols used; there is a medium latency, which is based on sending and receiving packets between the mobile device 902 and the wireless device 908; there is a lower amount of power consumed; often, the protocol to determine WFPS location data 916 is only available indoors; and, there is a requirement for availability of the wireless communication protocol. In some examples, information regarding the locations of wireless devices 908 is needed to receive or determine location data 916. For example, the location of APs is needed for some WFPS location data 916 and the location of the APs is stored in a database accessible via the internet. The database of APs may include billions of mapped wireless networks, which is also referred to as WiFi networks. The storage of the information regarding the mapped WiFi networks is not feasible on the device 902 because of storage, processing, and update requirements. Access to the internet may provide the information needed to perform WFPS without the large storage needs. In some examples, the host device 905 provides the information regarding the mapped WiFi networks to the device 902. The host device 905 is a mobile device 114 of FIG. 5, in accordance with some examples.

In some examples the wireless device 908 uses other protocols to determine the location data 916 or to enable the mobile device 902 to determine the location data 916. In some examples, the wireless device 908 is used to receive or determine other types of location data 916. For example, location protocols of 5G network, IEEE 802.11az, proprietary protocols, Bluetooth® beacons, and so forth, are used to determine location data 916. In some examples to use some protocols the wireless device 908 has to operate as a particular type of wireless device such as access points (APs) of an IEEE 802.11 network for IEEE 802.11az location data 916.

In some examples, accessing on-mobile device sources 910 such as a PDR sensor to determine PDR location data 918 has the following characteristics: location data 918 from the PDR senor 1016 can be used to detect motion of the mobile device 902; the accuracy 1112 of the PDR location data 918 has a lower or medium precision since it is based on dead reckoning; the latency is lower since the PDR sensor 1016 is part of the mobile device 902; the power requirement is lower since the PDR sensor 1016 requires a lower amount of energy to operate than other location devices such as the GNSS receiver 1014; the PDR sensor 1016 works both indoors and outdoors; and, location data 918 needs to be supplemented since it provides only an offset from a last known location in terms of distance and direction.

When the PDR sensor 1016 detects motion, the motion is then used to determine if there has been a change in location, in accordance with some examples. For example, the PDR sensor 1016 detects motion that indicates the mobile device 902 was moved to the left and then moved to the right so that it is in the same location. The precision of PDR location data 918 varies depending on a wearer gait and step length calibration being known and determining an activity such as walking, running, and so forth, in accordance with some examples.

The clock 1020 returns a current time and can be used to assist in determining the current location 1046. For example, the clock 1020 may be used in conjunction with GNSS satellite 904 signals to determine a difference between when signals from different GNSS satellites 904 are received. The compass 1026 returns location data that indicates a direction of the mobile device 902. The direction is used to assist in determining the current location 1046. For example, the compass 1026 is used to determine the orientation of the mobile device 902 or to determine in which direction the mobile device 902 moved from the PDR location data 1104. The orientation 1022 can be used to generate location data 1104 that indicates an orientation of the mobile device 902. The altimeter 1032 generates location data 1104 that indicates an altitude 1118 of the mobile device 902. The altitude 1118 can be used to assist in determining the Z position of the mobile device 902. For example, the altitude 1118 indicates whether the mobile device 902 is at the bottom of a cliff or on the cliff's edge, which may be just a meter apart in X or Y. Other on-mobile device sources 910 have different characteristics 1106 and return different location data 918.

The location sources 1102 provide location data 912, 914, 916, 918 to the mobile device 902, where the location data 912, 914, 916, 918 indicates data related to the location of the mobile device 902. In some examples, the location data 912, 914, 916, 918, includes one or more of the components as described in Table 2. The location data 912, 914, 916, 918 is 2 dimensional (D), 3D (x, y, z), or 4D with time, in accordance with some examples. For example, altitude and locality are not included in some location data 912, 914, 916.

TABLE 2
Location Data Components

| Location Data | Contents of location data 1104 |
|---|---|
| Position 1116 | Different formats such as latitude and longitude |
| Latitude | [+−] DDD.DDDDD format where D indicates degrees. |
| Longitude | [+−] DDD.DDDDD format where D indicates degrees. |
| Accuracy | Estimated horizontal accuracy of this location. For |
| | example, plus or minus a number of meters. |
| Timestamp | Timestamp of the last known location fix in epoch time. |
| | The timestamp may be in Universal Time Coordinated |
| | (UTC) or another format. |
| Altitude 1118 | In some examples, an altitude in meters above a |
| | wideband global satellite (WGS) reference ellipsoid. |
| Locality | For example, city, state, and/or country. For example, |
| | “New York, New York, United States”. |
| Weather | For example, partly sunny with a temperature of 80 |
| | degrees Celsius. |

The PDR sensor 1016 provides a 2-dimensional (2D) offset, heading, and step count from a starting position, in accordance with some examples. In some examples, the PDR sensor 1016 operates continuously and therefore is useful to fill in the gaps between updates from the other positioning system that require more power or have a higher latency.

In some examples the location data 912, 914, 916, 918 is not sent after the positioning system has received the location request 920. For example, a location source such as the PDR sensor 1016 may not be operating properly, so it may not respond to the location request 920. The location source 1102 may not respond with location data 912, 914, 916, 918 because one of its requirements is not met. See for example, the requirements column in Table 1 above.

Additionally, internet access or quality may be too low for a location source 1102 such as wireless device 908 to operate. The host device 905 does not provide location data 914 unless the mobile device 902 is paired with the host device 905, in accordance with some examples. For example, the host device 905 and the mobile device 902 may not have a Bluetooth™ connection or the quality of the wireless connection may be too poor to transmit data for the mobile device 902 to pair with the host device 905. The host device 905, in such cases and other examples, provides location data 914 from another source. For example, the host device 905 determines its own location using a wireless device 908 or GNSS satellite 904 and then transmits the location data 914 that indicates a location of the host device 905 to the mobile device 902. The host device 905 may use other location sources to determine its location and send the location to the mobile device 902 in location data 914. See for example, the requirements column in Table 1 above.

In some examples, the host device 905 sends to the mobile device 902 an estimate of how far the mobile device 902 is from the host device 905 so that the mobile device 902 can use the estimate to determine its location based on the estimate of how far the mobile device 902 is from the host device 905 and the location of the host device 905. The estimate of how far the mobile device 902 is from the host device 905 is based on delays in wireless communications between the mobile device 902 and the host device 905, in accordance with some examples. The estimate is based on a strength of a received signal strength indicator (RSSI) with an indication of a power with which the signal was transmitted. The mobile device 902 or host device 905 estimates a distance based on the transmitted power used to transmit the signal and the RSSI, which is the power of the received signal.

In some examples, the host device 905 sends data to the mobile device 902 to assist it in performing GNSS satellite 904 operations. For example, the host device 905 sends almanac information to the mobile device 902 for performing GPS estimates so that the mobile device 902 does not have to download the almanac information from the GNSS satellite 904. In some examples, the host device 905 sends other information such as information about APs in an IEEE 802 network or base stations in a 3GPP or 5G network.

In some examples, the location sources 1102 provide location data 912, 914, 916, 918 that provides a location of the mobile device 902 without consideration for an orientation of the mobile device 902. Additionally, location sources that are part of the mobile device 902 provide orientation information to the mobile device 902, in accordance with some examples. In some examples, the PDR sensor 1016 provides additional location data that includes an orientation of the mobile device 902. In some examples, the mobile device 902 uses location data 912, 914, 916, 918 for changes in geographic location and uses other devices for determining an orientation of the mobile device 902. One or more of the location sources 1102 may provide a reverse geocoding service where a position 1116, which may include an altitude 1118, is provided as part of the location request 920 and the location data 912, 914, 916, 918 provides a locality and/or weather in response to the location request 920.

FIG. 10 illustrates a system 1000 for location determination for battery-constrained devices, in accordance with some examples. FIG. 11 illustrates a system 1100 for location determination for battery-constrained devices, in accordance with some examples. FIGS. 10 and 11 will be described in conjunction with one another.

The location service component 1048 provides, referring to FIG. 11, location data 1104 or update location responses 1103 to applications 1002 in response to an application (app) location requests 1003. The update location response 1103 includes one or more of location data 1130, freshness 1132, and subscriber 1134. The location data 1130 is the fused current location 1046. The freshness 1132 indicates the time when the current location 1046 was determined and/or a time when the location data 1104 was provided from a location source 1102. The subscriber 1134 indicates whether the location service component 1048 has taken an action such as ended or accepted the subscription 1128. The location service component 1048 may make the update location response 1103 available to applications 1002 to access without interacting with the location service component 1048. For example, the update location response 1103 is made accessible in a cache of the mobile device 902. Additionally, the applications 1002, which can include an operating system of the mobile device 902, can subscribe 1006 for update location responses 1103 periodically such as every fraction of a second to every hour or even every day or more. The applications 1002 may need one or more of the data items included in the update location response 1103.

An application 1002 is a process or component of the mobile device 902. The application 1002 may be executed by an interpreter of the mobile device 902. The location service component 1048 makes the updated location response 1103 available to the operating system so the application 1002 can access the updated location response 1103.

The location sources 1102 include on-mobile device sources 910 and external sources 1050. The PDR sensor 1016, compass 1026, clock 1020, orientation 1022, and altimeter 1032 are disclosed herein. The external sources 1050 including wireless device 908, host device 905, and GNSS satellites 904, which are disclosed herein.

The wireless component 1034 includes a GNSS receiver 1014 and one or more additional wireless receivers 1018. The wireless components 1034 are configured to communicate with external sources 1050. The wireless connection 1025 can be a slow speed connection such as Bluetooth® or a higher-speed communication protocol such as IEEE 802.11, 3GPP, 5G, WiFi, cellular network modem, or another communications protocol.

The wireless connection 1025 can be a communication protocol that operates in the 2.4 GHz frequency band that uses one of a Time Division Duplex (TDD) synchronous connection-oriented (SCO) link for audio transmission and an asynchronous connectionless (ACL) link for data transmission.

In some examples, the location service component 1048 is configured to perform Wi-Fi position system (WFPS) with one or more wireless devices 908 to provide positioning information based on triangulation. In some examples, the wireless devices 908 are two or more access points (APs) configured to operate in accordance with IEEE 802.11az to determine the location of the mobile device 902. Other positioning protocols are associated with 3GPP and proprietary protocols are available, which include other wireless devices 908 that are near to the mobile device 902 to provide location information such as a home transmitter location system. In some examples, the wireless receiver 1018 operates with light where the mobile device 902 includes a light sensor.

In some examples, the location service component 1048 scans for APs and their addresses such as a basic service set (BSS) identification (IDs) (BSSIDs), signal strength, frequency, and channel. The location service component 1048 may perform the scans in response to an application 1002 sending an app location request 1003 to the location service component 1048. In some examples, the host device 905 performs the scan and transmits the information or part of the information to the mobile device 902. In some examples, the scan saves a service set (SS) identification (ID) (SSID) of a collection of wireless devices 908. The information sent by the mobile device 902 to the host device 905 includes a list of APs, in accordance with some examples. In some examples, the host device 905 provides an application programming interface (API) to the mobile device 902. For example, getGeoLocationFromWFPS ( ) method, where the mobile device 902 provides an AP token to the host device 905 via the API; and the host device 905 returns a location of the AP corresponding to the AP token to the mobile device 902. The host device 905 can be co-located or nearly co-located with the mobile device 902. For example, the host device 905 can be a smart phone and the mobile device 902 can be a head-wearable apparatus 116. In some examples, the location service component 1048 determines a location from the host device 905 based on delays in wireless signals exchanged between the two wireless devices and uses the determined location to correct for a location given by the host device 905. For example, the host device 905 sends a current location to the mobile device 902 and the mobile device 902 determines that it is within a meter of the host device 905.

The current location 1046 can be estimated based on exchanging light. For example, the mobile device 902 exchanges light with another device and a delay in receiving a response along with a time to process and transmit the response is used to determine a distance from the other device. Triangulation is used if there is more than one other device or light sensor with which the mobile device 902 may exchange light. For example, the mobile device 902 may transmit light that is detected by one or more sensors of other devices. The other devices can transmit light back to the mobile device 902 and the mobile device 902 can then estimate a round trip time and use this information with the location of the other mobile device to determine the location of the mobile device 902. In other embodiments, a wireless device may transmit light that is received by the mobile device 902. The wireless device may wirelessly transmit other information to the mobile device 902 such as the location of the wireless device 902 and information that enables the wireless device 902 to determine a flight time of the light. The information may be timing information and a location of the wireless device.

The current location 1046 can be estimated by processing images from camera 1021. For example, the object detection module 1035 may process the images captured by the camera 1021 and determine a location based on the objected detected. For example, the user may be in front of a landmark and the object detection module 1035 may be able to determine the identity of the landmark and its location. The object detection module 1035 may further be able to detect how far the mobile device 902 is from the landmark and estimate location data 1104. In other examples, the object detection module 1035 may identify familiar objects in the home of the user be able to determine a distance the mobile device 902 is from the familiar object. The object detection module 902 may use multiple objects and use perspective gained from two images taken simultaneously from two cameras such as cameras 869 of FIG. 8. In some embodiments, the object detection module 1035 sends the images to another device for processing such as host device 905, which may return positions of objects within a three-dimensional world coordinate system and location data 1104 of the mobile device 902. The object detection module 1035 may then use the now known positions of objects to determine future location data 1104 based on new images captured by the camera 1021.

The GNSS receiver 1014 communicates with GNSS satellite 904. The location service component 1048 is a centralized entity for acquisition, management and aggregation of current location 1046 data. The services provided by the location service component 1048 are termed location services for the applications 1002, in accordance with some examples.

The privacy module 1007 ensures that the location data 1130 of the mobile device 902 remains private. The privacy module 1007 removes the location data 1130 from the mobile device 902 periodically for privacy reasons. For example, the privacy module 1007 removes the location data 1130 once a day or each time the mobile device 902 is turned off.

The battery 1030 provides power to the mobile device 902. The battery 1030 provides a current charge state in accordance with some embodiments. The conditions 1024 relate to the use of the location sources 1102. The conditions 1024 include the conditions-to-use 1115, which are disclosed herein. The conditions 1024 include states of the mobile device 902 that may affect the characteristics 1106 of the location sources 1102. For example, the conditions 1024 include whether the mobile device 902 is indoors or outdoors, which may affect the power 1108 and latency 1110 of using the GNSS satellite 904. In another example, the conditions 1024 include whether a current location fix of the GNSS satellites 904 has already been obtained, which would reduce the power 1108 and latency 1110 to use the GNSS satellites 904. Another condition 1024 is the charge state of the battery 1030. For example, a very-low charge state of the battery 1030 may indicate that a lower power location source 1102 must or should be used. Another condition 1024 is the state of a display such as an image display of optical assembly 518 of FIG. 5 or a display as discussed in conjunction with FIG. 8.

The fusion component 1044 takes a current location 1046 and location data 1104 received from one or more of the location sources 1102 and generates a new current location 1046. The fusion component 1044 uses Equation (1) to determine the updated current location 1046, in accordance with some examples.

Equation (1): x,y,z=((x1, y1, z1)*(1/accuracy1)+ (x2,y2,z2)*(1/accuracy2))/(delta distance), where x, y, z, are the coordinates of the generated new current location 1046 that is being determined; x1, y1, z1 are the coordinates of the last determined current location 1046; x2, y2, z2 are the coordinates of location data 1104, which is the new location data 1104; accuracy1 is the accuracy of the last determined current location 1046; accuracy2 is the accuracy of new location data 1104; and delta distance is an estimated distance or Euclidean distance the mobile device 902 has moved between the last determined current location 1046 and the new location data 1104. In some examples, “*” is termed multiply or times and represents the mathematical operation of multiplication. X may be referred to as an x value; y may be referred to as a y value; x1 may be referred to as a x1 value; z may be referred to as a z value; y1 may be referred to as a y1 value; z1 may be referred to as a z1 value; z2 may be referred to as a z2 value; y2 may be referred to as a y2 value; and, x2 may be referred to as an x2 value.

In some examples, the app location request 1003 includes one or more of: a priority 1122, accuracy 1124, freshness 1126, time 1127, and a subscription 1128. The priority 1122 indicates a priority that can be used to determine whether to satisfy the app location request 1003 in accordance with the other data fields.

In some examples, the location service component 1048 determines whether the current location 1046 is sufficient to satisfy the app location request 1003. For example, a determination is made whether the accuracy 1119 and time 1117 of the current location 1046 is sufficient to satisfy the accuracy 1124 and the freshness 1126 of the app location request 1003.

The app location request 1003 may include other 1129, which indicates other type of requests or constraints on the current location 1046. For example, the other 1129 indicates that a locality corresponding to the current location 1046 is provided. The locality may be a street, a city, a state, county, town, city, country, a government jurisdiction, a venue, or another indication of a name associated with the current location 1046. The other data 1120 may include a locality, altitude, velocity, weather, and so forth.

The time 1127 indicates when the app location request 1003 would like the location request satisfied. The time 1127 is also referred to herein as a satisfaction time 1127. The time 1127 can be immediate or a time 1127 in the future such as in 1 millisecond, 1 second, 10 seconds, before the mobile device 902 is turned off or goes into a sleep state, and so forth. In some examples, the app location request 1003 includes a subscription 1128 request, which indicates a periodicity for when a current location 1046 is requested that satisfies the accuracy 1124 and freshness 1126. The location service component 1048 evaluates the subscription 1128 request and adds the application 1002 that generated the subscription 1128 request as a subscriber 1144 with an indication of the location request 1146 and a periodicity 1148 of the location request 1146.

The metrics component 1140 determines metrics 1142 of the performance of providing current location 1046. The metrics 1142 are divided into three categories. A first category of metrics 1142 related to location-related settings or availability of data on the mobile device 902. The metric component 1140 maintains one or more of the following: location availability, which indicates whether a current location 1046 was provided or not provided; what caused an unavailability such as unavailability of a wireless device 908; and, a diversity of location sources 1102 used or available during a session, where a session may be a duration such the time between when the mobile device 902 is turned on and when the mobile device 902 is either turned off or going into a sleep mode. Another metric 1142 is an age of the current location 1046 provided to the application 1002, which may be a time between the app location request 1003 and the time 1117 of the location data 1104 of the current location 1046. In some examples, the age of the current location 1046 provided to the application is a time between the time 1127 indicated on the app location request 1003 and the time 1117 of the location data 1104 of the current location 1046. The age of the current location 1046 is less critical for some applications 1002 such as an image capturing application 1002 that would like to associate a current location 1046 compared with other applications 1002 such as an application 1002 that provides real-time directions. The freshness 1126 indicates an acceptable difference between the time 1117 of the location data 1104 and a time the update location response 1103 is provided.

Another metric 1142 determined by the metric component 1140 is a duration of frequent location usage or how often requests for a current location 1046 are received. In some examples, the metric component 1140 determines that app location requests 1003 are frequent if at least 1 app location request 1003 is received per second. Another metric 1142 is a number of subscribers 1144 and duration on the mobile device 902. Another metric 1142 is a “cold fix,” which is when the location service component 1048 needs to determine a current location 1046 without a previous current location 1046.

In some examples, the metrics component 1140 maintains metrics 1142 related to service health and performance metrics. An example metric 1142 is latency of processing an app location request 1003. In some examples, the metrics component 1140 maintains metrics 1142 related to system health metrics. Example metrics 1142 include a memory usage of the location service component 1048. Another example metric 1142 is power consumption of applications 1002 and power consumption of satisfying the app location requests 1003 of the applications 1002. Another metric 1142 includes determining a cost of each location source 1102 associated with returning fresh location data 1104. For example, for WFPS data, the cost is scanning for wireless device 908 that are WiFi APs and then an Internet network request to find the location of the WiFi APs. For GNSS location data 1104, the cost is of powering the GNSS receiver 1014, acquiring, and then tracking enough GNSS satellites 904 to determine a position 1116. In some examples, the metric component 1140 determines an estimated power of each location source 1102 by dividing the total power used by the location source 1102 by the number of location requests 920 made to that location source 1102.

In some examples, the metric component 1140 includes the time or latency 1110 it takes from location request 920 to when the location data 1104 is available, which may be termed a response. The metrics component 1140 adjusts the characteristics 1106 of the location sources 1102 based on the metrics 1142.

The location service component 1048 determines a location request 920 to make to a location source 1102 based on app location requests 1003. In some examples, the location service component 1048 makes additional location requests 920 so that a current location 1046 is available soon after the mobile device 902 is turned on. The location service component 1048 attempts to lower the latency that an application 1002 experiences when trying to access the current location 1046.

The update scheduler component 1042 determines the next location request 920 to make to one or more location sources 1102. The update scheduler component 1042, in some examples, lessens or minimizes an amount of power 1108 used to satisfy the app location request 1003. The location service component 1048 can make location requests 920 periodically to keep the current location 1046 fresh in anticipation of app location requests 1003. The update scheduler component 1042 can make periodic location requests 920 based on which applications 1002 are active on the mobile device 902. In determining an appropriate location source 1102, the update scheduler component 1042 uses the fusion component 1044 to determine how accurate 1119 the location data 1104 has to be considering the current accuracy 1119 of the current location 1046.

In some examples, the update scheduler component 1042 utilizes the PDR sensor 1016 to determine when a location request 920 is necessary. For example, if an app location request 1003 is for an accuracy 1124, which is high, and the freshness 1126 indicates the current location 1046 needs to be very current, the update schedule component 1042 can determine not to make a location request 920 if the PDR sensor 1016 indicates the mobile device 902 has not moved or that the amount of movement has not transgressed, or is not greater than, a threshold associated with the accuracy 1124 of the app location request 1003 and an accuracy associated with the current location 1046.

An app location request 1003 can include a request for a locality or weather. In some examples, the location service component 1048 utilizes another application 1002 that returns the locality or weather given the current location 1046. In some examples, a location source 1102 returns the weather for the current location 1046 or returns the locality for the current location 1046.

The update scheduler component 1042, in some examples, determines the location request 920 based on the app location requests 1003 in the queues 1138. In some examples, the location service component selects an app location request 1003 from the queues 1138 with a highest accuracy 1124 request. The location data 1104 is returned that satisfies the selected app location request 1003 and also satisfies other pending app location requests 1003 in the queues 1138 that have app location request 1003 times 1127 before or at the same time 1127 of the selected app location request 1003. The update schedule component 1042 determines a final time when the app location request 1003 needs to be satisfied with a current location 1046 based on when the application location request 1003 is received or a time 1127 of the app location request 1003.

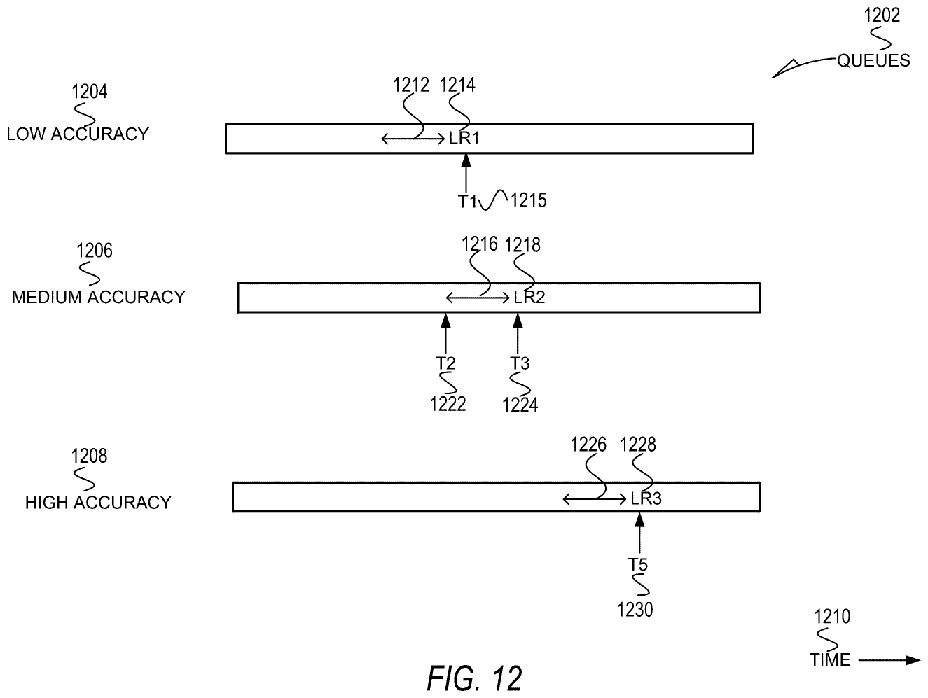

FIG. 12 illustrates queues 1202, in accordance with some examples. The time 1210 indicates a direction of time. The queues 1202 include a low accuracy 1204 queue, a medium accuracy 1206 queue, and a high accuracy 1208 queue. The low accuracy 1204 queue includes location request (LR) 1 (LR1) 1214, T1 1215, and location data freshness 1212. T1 1215 indicates the time 1127 when the location data is requested. LR1 1214 is an app location request 1003 that was placed on the low accuracy 1204 queue by the update schedule component 1042 because the app location request 1003 requested a subscription 1128, in one example. In another example, the LR1 1214 was placed on the low accuracy 1204 queue based on receiving an app location request 1003 with a time 1127 that is not a present time but time T1 1215. The update scheduler component 1042 can place LR1 1214 on the low accuracy 1204 queue for another reason, in other examples. Freshness 1212 indicates an acceptable age of the current location 1046 in satisfying LR1 1214. The location service component 1048 satisfies an app location request 1003 by sending or making the location data 1130 available to the application. In some examples, the update schedule component 1042 adjusts the freshness 1212 based on data from PDR sensor 1016 and/or a determined current velocity of the mobile device 902 where the more the mobile device 902 is moving the more the freshness 1212 is reduced.

LR2 1218 is an app location request 1003 in the medium accuracy 1206 queue. T3 1224 is the time 1127 when the application 1002 corresponding to LR2 1218 requests the current location 1046 be sent or made available to the application 1002. T2 1222 is the end of the freshness 1216. So, when the app location request 1003 is received the update schedule component 1042 can use a current location 1046 that has a time 1117 on or after T2 1222.

LR3 1228 is an app location request 1003 in the high accuracy 1208 queue that has been placed on the high accuracy 1208 queue by the update schedule component 1042, in one example. Freshness 1226 indicates an acceptable age of the current location 1046 in satisfying LR3 1230.

In some examples, the update schedule component 1042 selects the highest accuracy app location request 1003 that satisfies all other pending app location requests 1003 before the highest accuracy app location request 1003. For example, in FIG. 12, the update schedule component 1042 determines a location source 1102 to use based on the current location 1046, conditions 1024, and the pending app location requests 1003 of LR1 1214 and LR2 1218. Based on the freshness 1226 and time T5 1230, the update schedule component 1042 determines that LR3 1228 cannot be satisfied with location data 1130 used to satisfy LR2 1218. The location source 1102 can be selected based on using a lower or minimum power 1108 location source 1102 but still satisfying LR1 1214 and LR2 1218.

The update scheduler component 1042 generates a location request 920 to one of the location sources 1102. For example, the update scheduler component 1042 determines that WFPS is available based on the conditions 1024 and that the location data 1104 returned by WFPS satisfies the accuracy 1124 requirement of LR2 1218 and the latency 1110 will provide the location data 1104 by the time 1127 when the location data 1104 is requested. The selected location source 1102 returns location data 1104. The fusion component 1044 fuses the location data 1104 with the current location 1046. The update schedule component 1042 then either makes the location data 1104 available such as in a memory of the mobile device 902 or generates an update location response 1103 to send to the application 1002 corresponding LR2 1218. Additionally, LR1 1214 is satisfied using the same location data 1130 used to satisfy LR2 1218. By satisfying LR2 1218 first, the update scheduler component 1042 reduces the number of location requests 920 because it does not have to first satisfy LR1 1214 and then satisfy LR2 1218. If LR1 1214 were satisfied first, then the location data 1130 used to satisfy LR1 1214 could not be used to satisfy LR2 1218 because the accuracy requirement would not be met.

The update scheduler component 1042 then can remove LR1 1214 and LR2 1218 from the queues 1202. If the freshness 1226 extends to T3 1224, then the location data 1104 from satisfying LR2 1218 can be used to satisfy LR3 1228. Otherwise, the update scheduler component 1042 will determine how best to satisfy LR3 1228. In determining the location source 1102, the update scheduler component 1042 determines that the latency 1110 that is needed to receive the location data 1104. The latency 1110 is adjusted based on the conditions 1024. For example, the latency for WFPS is reduced if the mobile device 902 already has the location or position of a number of nearby APs that can be used to perform WFPS and the mobile device 902 determines the signal strength of the APs is strong enough to perform WFPS. In some examples, the update scheduler component 1042 generates a schedule 1040 of location requests 920 to be sent to the location sources 1102. For example, the update schedule component 1042 schedules a location request 920 to the PDR sensor 1016 every several minutes to detect whether the mobile device 902 has moved. In some examples, the schedule 1040 is generated to satisfy a subscription 1128. For example, a real-time XR application 1002 may need up-to-date location data 1104 every fraction of a second. The update schedule component 1042 sets up a schedule 1040 to generate a location request 920 every fraction of a second to the location source 1102 for the GNSS satellite 904.

In some examples, the update scheduler component 1042 clears or cancels one or more subscriptions 1128 based on one or more conditions 1024 such as a display being turned off, the mobile device 902 entering a sleep state, or another condition 1024.

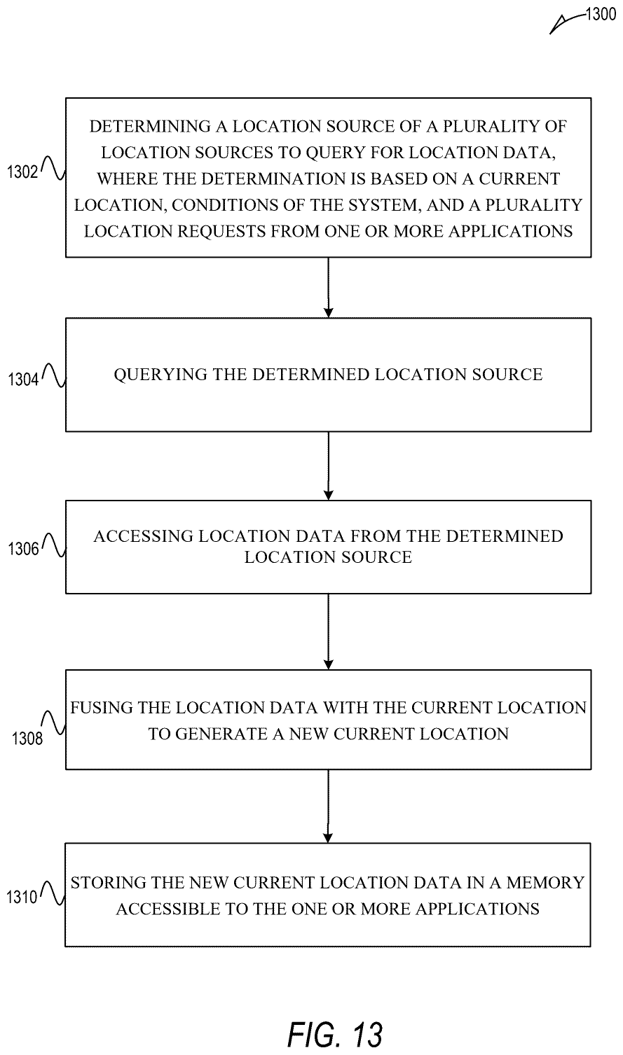

FIG. 13 illustrates a method 1300 for location determination for battery-constrained devices, in accordance with some examples. The method 1300 begins at operation 1302 with the location service component 1048 determining a location source of a plurality of location sources to query for location data. In some examples, the determination is based on a current location, conditions of the mobile device 902, and a plurality location requests from one or more applications. For example, update scheduler component 1042 examines the queues 1138 and determines to select a location source 1102 of WFPS to satisfy LR1 1214 and LR2 1218 as discussed in conjunction with FIG. 12. The conditions 1024 indicate that wireless devices 908 are available to perform WFPS with. The update scheduler component 1042 uses the fusion component 1044 to determine the level of accuracy 1124 needed for the location data 1104 and/or an estimated movement of the wireless device 902 based on data from the PDR sensor 1016. The update schedule component 1042 selects the location source 1102 that minimizes the power 1108 used to conserve the battery 1030.

The method 1300 continues at operation 1304 with querying the determined location source. For example, the update scheduler component 1042 generates a location request 920 for a location source 1102 that determines the location data 1104 based on WFPS.

The method 1300 continues at operation 1306 accessing location data from the determined location source. For example, the update scheduler component 1042 accesses the location data 1104, which may be sent to the update scheduler component 1042 in the form of return data from a procedure call.

The method 1300 continues at operation 1308 with fusing the location data with the current location to generate a new current location. For example, the update scheduler component 1042 uses the fusion component 1044 to fuse the current location 1046 with the location data 1104.

In some examples, the method 1300 includes where the plurality of location requests comprises at least one of a priority, an accuracy, or a freshness. For example, app location request 1003 discussed in conjunction with FIG. 10. In some examples, the method 1300 includes determining the location source further based on a power usage, an accuracy, and latency of the plurality of location sources. For example, the update scheduler component 1042 selects the location source 1102 further based on a power usage, an accuracy, and latency of the plurality of location sources as discussed in conjunction with FIG. 11.

In some examples, the method 1300 further includes adjusting a latency of a location source of the plurality of location sources based on the conditions of the system as discussed in conjunction with FIGS. 10 and 11.

In some examples, the method 1300 includes reducing a latency of the location source for a global navigation satellite system (GNSS) if the system has AGNSS data as discussed in conjunction with FIGS. 10 and 11.

In some examples, the method 1300 includes determining the location source further based on the location source requiring less power than other location sources of the plurality of location sources and the location source satisfying the accuracy and freshness of a location request of the plurality of location requests as discussed in conjunction with FIGS. 10 and 11.

In some examples, the method 1300 includes where the plurality of location requests further comprises times for when the location data is needed as discussed in conjunction with FIGS. 10 and 11. In some examples, the method 1300 includes selecting, to satisfy, the location request of the plurality of location requests, with a highest accuracy requirement, wherein the location data returned by satisfying the selected location request satisfies location requests of the plurality of location requests that have satisfaction times not after a time of the selected location request as discussed in conjunction with FIGS. 10 and 11.

In some examples, the method 1300 includes determining that one or more location requests of the plurality of location requests are satisfied based on corresponding times of the one or more location requests less corresponding freshnesses being less than a time of the new current location as discussed in conjunction with FIGS. 10 and 11.

In some examples, the method 1300 includes determining the location source is further based on an accuracy of the current location as discussed in conjunction with FIGS. 10 and 11.

In some examples, the method 1300 includes where the new current location comprises: an x value, a y value, and a z value, the current location comprises: an x1 value, a y1 value, and a z1 value, and the location data comprises: an x2 value, a y2 value, and a z2 value, and wherein fusing further comprises: determining the x value, the y value, and the z value based on: the x1 value, the y1 value, and the z1 value; the x2 value, the y2 value, and the z2 value; and, an accuracy of the current location, and an accuracy of the location data. For example, equation (1) discloses a method of fusing two locations.

In some examples, the method 1300 includes determining metrics of performance of the plurality of location sources and updating powers and latencies of the plurality of location sources based on the metrics as discussed in conjunction with FIGS. 10 and 11. The method 1300 may be performed by a computing device disclosed herein such as an apparatus of XR glasses.

The method 1300 continues at operation 1310 with storing the new current location data in a memory accessible to the one or more applications. For example, the update scheduler component 1042 sends the new current location data to the application 1002 corresponding to the app location request 1003. In some examples, the update scheduler component 1042 causes the new current location data to be available to the applications 1002 by placing the new current location data in a memory location or by making the new current location data available to an operating system of the mobile device 902.

One or more of the operations of method 1300 can be optional. For example, operation 1308 can be optional. Method 1300 can include one or more additional operations. The operations of method 1300 can be performed in a different order.

### EXAMPLE STATEMENTS

Example 1 is a system comprising: at least one processor; at least one memory component storing instructions that, when executed by the at least one processor, cause the at least one processor to perform operations comprising: determining a location source of a plurality of location sources to query for location data, wherein the determination is based on a current location, conditions of the system, and a plurality of location requests from one or more applications; querying the determined location source; accessing location data from the determined location source; fusing the location data with the current location to generate a new current location; and storing the new current location in a memory accessible to the one or more applications.

In Example 2, the subject matter of Example 1 includes, wherein the plurality of location requests comprise at least one of a priority, an accuracy, or a freshness.

In Example 3, the subject matter of any of Examples 1-2 includes, wherein the determining the location source further comprises: determining the location source further based on a power usage, an accuracy, and latency of the plurality of location sources.

In Example 4, the subject matter of any of Examples 1-3 includes, wherein the operations further comprise: adjusting a latency of a location source of the plurality of location sources based on the conditions of the system.

In Example 5, the subject matter of any of Example 4 includes, wherein a latency of the location source for a global navigation satellite system (GNSS) is reduced if the system has assisted global navigation satellite system (GNSS) (AGNSS) data.

In Example 6, the subject matter of any of Examples 3-5 includes, wherein the determining the location source further comprises: determining the location source further based on the location source requiring less power than other location sources of the plurality of location sources and the location source satisfying the accuracy and freshness of a location request of the plurality of location requests.

In Example 7, the subject matter of any of Example 6 includes, wherein the plurality of location requests further comprises times for when the location data is needed.

In Example 8, the subject matter of any of Examples 6-7 includes, wherein the operations further comprise: selecting the location request of the plurality of location requests, to satisfy, with a highest accuracy, wherein the location data returned by satisfying the selected location request satisfies location requests of the plurality of location requests that have satisfaction times not after a time of the selected location request.

In Example 9, the subject matter of any of Example 8 includes, wherein the operations further comprise: determine one or more location requests of the plurality of location requests are satisfied based on corresponding times of the one or more location requests less corresponding freshnesses being less than a time of the new current location.

In Example 10, the subject matter of any of Examples 1-9 includes, wherein the determining the location source is further based on an accuracy of the current location.

In Example 11, the subject matter of any of Examples 1-10 includes, value, and wherein fusing further comprises: determining the x value, the y value, and the z value based on: the x1 value, the y1 value, and the z1 value; the x2 value, the y2 value, and the z2 value; and, an accuracy of the current location, and an accuracy of the location data.

In Example 12, the subject matter of any of Examples 1-11 includes, wherein the conditions of the system determine which location sources of the plurality of location sources are available for querying.

In Example 13, the subject matter of any of Examples 1-12 includes, wherein the conditions of the system further determine an amount of power consumed by the plurality of location sources and a latency of the plurality of location sources.

In Example 14, the subject matter of any of Examples 1-13 includes, wherein the operations further comprise: determining metrics of performance of the plurality of location sources; and updating powers and latencies of the plurality of location sources based on the metrics.

In Example 15, the subject matter of any of Examples 1-14 includes, wherein the system is an apparatus of extended reality (XR) glasses.

Example 16 is a method performed on a system comprising: determining a location source of a plurality of location sources to query for location data, wherein the determination is based on a current location, conditions of the system, and a plurality of location requests from one or more applications; querying the determined location source; accessing location data from the determined location source; fusing the location data with the current location to generate a new current location; and storing the new current location in a memory accessible to the one or more applications.

In Example 17, the subject matter of Example 16 includes, wherein the plurality of location requests comprise at least one of a priority, an accuracy, or a freshness.

Example 18 is a non-transitory computer-readable storage medium storing instructions that, when executed by at least one processor of a system, cause the at least one processor to perform operations comprising: determining a location source of a plurality of location sources to query for location data, wherein the determination is based on a current location, conditions of the system, and a plurality of location requests from one or more applications; querying the determined location source; accessing location data from the determined location source; fusing the location data with the current location to generate a new current location; and storing the new current location in a memory accessible to the one or more applications.

In Example 19, the subject matter of Example 18 includes, wherein the plurality of location requests comprise at least one of a priority, an accuracy, or a freshness.

In Example 20, the subject matter of any of Examples 18-19 includes, wherein the determining the location source further comprises: determining the location source further based on a power usage, an accuracy, and latency of the plurality of location sources.

Example 21 is at least one machine-readable medium including instructions that, when executed by processing circuitry, cause the processing circuitry to perform operations to implement of any of Examples 1-20.

Example 22 is an apparatus comprising means to implement any of Examples 1-20.

Example 23 is a system to implement of any of Examples 1-20.

Example 24 is a method to implement of any of Examples 1-20.

### Term Examples

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, network attached storage (NAS), storage area networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
determining a location source of a plurality of location sources to query for location data, the determination based on a current location, conditions of the system, and a plurality of location requests from one or more applications;
querying the determined location source;
accessing location data from the determined location source;
fusing the location data with the current location to generate a new current location; and
storing the new current location in a memory accessible to the one or more applications.

2. The system of claim 1, wherein the plurality of location requests comprise at least one of a priority, an accuracy, or a freshness.

3. The system of claim 1, wherein determining the location source is further based on a power usage, an accuracy, and latency of the plurality of location sources.

4. The system of claim 1, wherein the operations further comprise:
adjusting a latency of a location source of the plurality of location sources based on the conditions of the system.

5. The system of claim 4, wherein a latency of the location source for a global navigation satellite system (GNSS) is reduced if the system has assisted global navigation satellite system (GNSS) (AGNSS) data.

6. The system of claim 3, wherein determining the location source is further based on the location source requiring less power than other location sources of the plurality of location sources and the location source satisfying the accuracy and freshness of a location request of the plurality of location requests.

7. The system of claim 6, wherein the plurality of location requests further comprises times for when the location data is needed.

8. The system of claim 6, wherein the operations further comprise:
selecting, to satisfy, the location request of the plurality of location requests, with a highest accuracy requirement, wherein the location data returned by satisfying the selected location request satisfies location requests of the plurality of location requests that have satisfaction times not after a time of the selected location request.

9. The system of claim 8, wherein the operations further comprise:
determining that one or more location requests of the plurality of location requests are satisfied based on corresponding times of the one or more location requests less corresponding freshnesses being less than a time of the new current location.

10. The system of claim 1, wherein the determining the location source is further based on an accuracy of the current location.

11. The system of claim 1, wherein the new current location comprises: an x value, a y value, and a z value, the current location comprises: an x1 value, a y1 value, and a z1 value, and the location data comprises: an x2 value, a y2 value, and a z2 value, and wherein fusing further comprises:
determining the x value, the y value, and the z value based on: the x1 value, the y1 value, and the z1 value; the x2 value, the y2 value, and the z2 value; and, an accuracy of the current location, and an accuracy of the location data.

12. The system of claim 1, wherein the conditions of the system determine which location sources of the plurality of location sources are available for querying.

13. The system of claim 1, wherein the conditions of the system further determine an amount of power consumed by the plurality of location sources and a latency of the plurality of location sources.

14. The system of claim 1, wherein the operations further comprise:
determining metrics of performance of the plurality of location sources; and
updating powers and latencies of the plurality of location sources based on the metrics.

15. The system of claim 1, wherein the system is an apparatus of extended reality (XR) glasses.

16. The system of claim 1, wherein the system further comprises a camera, and wherein the querying the determined location source further comprises:
capturing one or more images using a camera;
identifying an object within the one or more images; and
determining a location of the system based on a known location of the object.

17. A method performed on a system comprising:
determining a location source of a plurality of location sources to query for location data, the determination based on a current location, conditions of the system, and a plurality of location requests from one or more applications;
querying the determined location source;
accessing location data from the determined location source;
fusing the location data with the current location to generate a new current location; and
storing the new current location in a memory accessible to the one or more applications.

18. The method of claim 17, wherein the plurality of location requests comprise at least one of a priority, an accuracy, or a freshness.

19. A non-transitory computer-readable storage medium storing instructions that, when executed by at least one processor of a system, cause the at least one processor to perform operations comprising:
determining a location source of a plurality of location sources to query for location data, the determination based on a current location, conditions of the system, and a plurality of location requests from one or more applications;
querying the determined location source;
accessing location data from the determined location source;
fusing the location data with the current location to generate a new current location; and
storing the new current location in a memory accessible to the one or more applications.

20. The non-transitory computer-readable storage medium of claim 18, wherein the plurality of location requests comprise at least one of a priority, an accuracy, or a freshness.
